(19) United States
(12) Patent Application Publication
(10) Pub. No.: US 2025/0315030 A1
(43) Pub. Date: Oct. 9, 2025

(54) METHODS AND APPARATUS TO IMPLEMENT MULTI-ASPECT OBJECTS FOR CONTROL SYSTEMS

(71) Applicant: Intelligent Platforms, LLC, Charlottesville, VA (US)

(72) Inventors: Keith G. McNab, Albany, NY (US); Michael Joseph Yoensky, Charlottesville, VA (US); Thomas Lee Williams, Minneapolis, MN (US); Samuel Barbour Prescott, Richmond, VA (US); Dhanashree Pandharkar, McKinney, TX (US); Guimin Zhang, Charlottesville, VA (US); Richard Alan Carpenter, Charlottesville, VA (US); Patrick Peter Noel Arial, Gordonsville, VA (US)

(21) Appl. No.: 18/629,629

(22) Filed: Apr. 8, 2024

(51) Int. Cl. G05B 19/418

(52) U.S. Cl. CPC G05B 19/41835; G05B 2219/31229

(57) ABSTRACT

Disclosed examples create a multi-aspect object, the multi-aspect object represented using a class definition; assign a first capability to the multi-aspect object, the first capability to communicate with equipment in a control system; assign a second capability to the multi-aspect object, the second capability to communicate with the equipment in the control system; create a semantic data model in the multi-aspect object, the semantic data model to share information between the first capability and the second capability of the multi-aspect object; deploy the first capability of the multi-aspect object on a first runtime platform; and deploy the second capability of the multi-aspect object on a second runtime platform, the semantic data model to communicate between the first and second runtime platforms to share the information between the first and second capabilities of the multi-aspect object.

### FIELD OF THE DISCLOSURE

This disclosure relates generally to distributed control systems and, more particularly, to methods and apparatus to implement multi-aspect objects for control systems.

### BACKGROUND

Industrial control automation is used in processing industries to manufacture different types of materials and products. Industrial control automation systems include controllers connected to equipment in an environment. The equipment may include devices to manipulate a process and/or may include sensors to collect monitoring data in the process.

### BRIEF DESCRIPTION OF THE DRAWINGS

FIG. 1 is an example network environment to implement multi-aspect objects for control systems.

FIG. 2 is an illustration of a physical model of equipment in a distributed control system and a corresponding control functional model including multi-aspect objects to interact with the equipment in the physical model.

FIG. 3 is an example development environment to generate and deploy the multi-aspect objects of FIG. 2.

FIG. 4 illustrates example multi-aspect objects created based on the same multi-aspect object template published in a programmable automation control (PAC) innovation hub of FIGS. 1 and 3.

FIG. 5 is an example inner and outer control environment implementable by an edge aspect of a multi-aspect object.

FIG. 6 is the example multi-aspect object builder of FIGS. 1 and 3 that may be used to configure multi-aspect object templates and simulate corresponding multi-aspect objects to control equipment in a control system.

FIG. 7 is a flowchart representative of example machine readable instructions and/or example operations that may be executed, instantiated, and/or performed by example programmable circuitry to implement the multi-aspect object builder of FIGS. 1, 3, and 6 to create multi-aspect object templates.

FIG. 8 is a flowchart representative of example machine readable instructions and/or example operations that may be executed, instantiated, and/or performed by example programmable circuitry to implement the solution builder of FIGS. 1 and 3 to generate multi-aspect objects based on multi-aspect object templates.

FIG. 9 is a block diagram of an example processing platform including programmable circuitry structured to execute, instantiate, and/or perform the example machine-readable instructions and/or operations of FIGS. 7 and 8 to implement the design hub, the multi-aspect object builder, the solution builder, or the deployment environment of FIG. 1.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine-readable instructions of FIGS. 7 and 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawings and accompanying written description to refer to the same or like parts. The figures are not necessarily to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

### DETAILED DESCRIPTION

Examples disclosed herein may be used to implement multi-aspect objects, also referred to herein as industrial objects, for use in control systems (e.g., industrial control systems, industrial automation control systems, hybrid control systems, etc.) also referred to herein as distributed control systems. Such control systems may be continuous control systems, discrete control systems, or hybrid control systems. A continuous control system is used to control processes that are uninterrupted with variables such as flow that change smoothly over time. A discrete control system is used to control processes that handle/manufacture discrete items and in which operations can be performed at discrete points in time with fewer time-based synchronization constraints or dependencies between operations. An example discrete control system uses switches to move individual items between different locations in a manufacturing facility. A hybrid system is a control system that includes both continuous control system and discrete control system portions.

Examples disclosed herein provide an ecosystem of tools and runtime platforms to create and use multi-aspect objects for use in industrial automation. As used herein, an object is a group of machine-readable instructions and/or data that program or configure programmable circuitry (e.g., a processor, a controller, a Field Programmable Gate Array (FPGA), etc.) to perform one or more operations. Instructions to create an object may be programmed manually or through automated processes with or without user input. In examples disclosed herein, multi-aspect object templates of Industrial Object Type (“IndObject Type”) are created to subsequently instantiate multi-aspect objects. As used herein, an IndObject Type is a class definition for use in software programming and for which multiple capabilities can be created to automate re-useability and re-configurability of a component within the context of a control system. The class IndObject Type may alternatively be referred to as a Module Type in some implementations. In examples disclosed herein, each capability that the IndObject Type provides is referred to as an aspect. Aspects of an IndObject Type include machine-readable instructions and/or data to configure parameters in hardware to cause such hardware to perform one or more operations. Examples of such hardware include controllers, field devices (e.g., pumps, valves, actuators, solenoids, pressure regulators, etc.), sensors (e.g., fluid level sensors, temperature sensors, pressure sensors, etc.). An IndObject Type can provide an extensible number of aspects to implement a multitude of capabilities in a control automation system. For example, it can provide a control aspect to control physical equipment via logic in a programmable logic controller (PLC), a human-machine interface (HMI) aspect that provides user interfaces (e.g., graphical user interface (GUIs)) to monitor and operate physical equipment, and an edge aspect to generate and analyze analytic information of physical equipment over time to gain insights on how to adjust setpoints and/or general adjustable parameters (e.g., how to optimize parameters of the physical equipment to optimize performance). Aspects that are part of the same multi-aspect object share a semantic data model that allows the aspects to seamlessly share information.

When a multi-aspect object template of IndObject Type is used to instantiate a multi-aspect object, each aspect of the multi-aspect object can be deployed onto a corresponding runtime platform and is useable to serve different purposes. As such, the multi-aspect object template is a reusable and distributed object model that defines aspects that can run across multiple runtime platforms. In addition, the data communications between the aspects are automatically configured to use the shared sematic data model. In this manner, the semantic data model spans all of the aspects of the multi-aspect object. For a multi-aspect object template defining a control aspect, an HMI aspect, and an edge aspect, instantiating a corresponding multi-aspect object results in functioning logic, HMI screens, and edge analytics. The edge aspect and the control aspect enable using one multi-aspect object to implement both inner and outer loop control for equipment by generating and analyzing analytic information of physical equipment over time to predict future behavior. Based on this predicted future behavior, the edge aspect can gain insights on useful parameterization changes and can make changes to parameters so that the control aspect can optimize the performance and/or life of the equipment under control.

Examples disclosed herein provide an integrated development environment (IDE) in which multi-aspect object templates of IndObject Type may be created and tested. For example, the IDE may be used to test multi-aspect object templates through simulation in a virtualized environment independent of actual physical equipment (e.g., physical hardware) to ensure that aspects and semantic data models defined in the multi-aspect object templates operate as expected before use for deploying multi-aspect objects in real environments.

Examples disclosed herein enable publishing multi-aspect object templates in a central object repository. Users can subsequently retrieve the multi-aspect object templates from the central object repository for use in different applications. In addition, users can update and/or customize multi-aspect object templates in the central object repository to suit different needs. In this manner, examples disclosed herein foster collaborative innovation in a control software development community. In some examples, multi-aspect object templates can be published to a commercial app store to be available to third-party users based on licensing and/or commercial monetization of such multi-aspect object templates.

In examples disclosed herein, an object model of multi-aspect object templates supports extensibility of aspects to add functionality to already existing aspects in the multi-aspect object templates. As such, a multi-aspect object template created by one user may be updated by a subsequent user to add one or more features related to, for example, alarm management, input/output (I/O) definition, performance tuning, etc. For example, alarm management may involve creating different alarm parameters or thresholds to issue alerts or alarms based on sensor readings and equipment status in a process control environment. To customize I/O definitions, a user may add, remove, or change the purpose of I/O ports defined in a multi-aspect object template to suit the needs of a corresponding process control environment. Similarly, to tune performance related to a multi-aspect object template, a user may use a performance tuner to optimize tradeoffs between different performance characteristics to improve the operation of the multi-aspect object template for the particular needs of that user. A multi-aspect object template may also be updated to suit different recipes for batch applications and/or to suit different requirements of time-sensitive networking.

Different versions of multi-aspect object templates can be tracked using version/source control as a service. Such version/source control can be used to inform users of different configurations of a multi-aspect object template so that users can select a variant that most closely suits their needs. Version/source control may also be used to rollback configurations of multi-aspect object templates that show signs of underperformance or incorrect operation over time. In this manner, many users in a control software development community may collaborate to monitor and improve published multi-aspect objects.

Examples disclosed herein may also be used to generate semantic data models through which control system data is communicated to and from different aspects of multi-aspect objects. For example, in a multi-aspect object, a semantic data model is shared between the different aspects of that multi-aspect object. The semantic data model is configured to operate as a conduit for control system data between a deployment of physical equipment and the aspects of a multi-aspect object. A semantic data model can be generated based on a semantic data model template in a multi-aspect object template. Such a semantic data model template can be used to configure a semantic data model to work with other aspects in a multi-aspect object.

Using examples disclosed herein, a developer that is knowledgeable in one aspect of a system can contribute to the design of a control system application starting from the position of that developer's familiarity with that one aspect. That is, based on an initial contribution of one aspect to a multi-aspect object template, configuration information of a first aspect template can be used to initiate a process to fill out information of other aspect templates subsequently added for use in the multi-aspect object template. For example, a programmer sufficiently familiar with control system logic can build an algorithm that will run on a distributed control system. Examples disclosed herein can subsequently incorporate that algorithm in a semantic data model template (e.g., an Open Platform Communications Unified Architecture (OPC UA) data model template) and then use that semantic data model template for other areas of the distributed control system. In another example, a programmer sufficiently familiar with HMI screens can create an HMI aspect template that includes configuration information that is incorporated in a semantic data model template. That HMI configuration information in the semantic data model template could be subsequently used to generate a control aspect template for a control aspect that will collaborate with the HMI screens during deployment. The control aspect template can be filled in by itself (e.g., by inheriting the HMI configuration information) or by another programmer that is familiar with control systems programming. In examples disclosed herein, such semantic data models can be shared between multiple aspects of a multi-aspect object. Providing multi-aspect object templating and different programmable aspects of a system enable using a semantic data model to infer the configuration and template formatting upon which other aspects relate in a multi-aspect object.

Examples disclosed herein can be used to generate many aspects based on a semantic data model and configure the semantic data model to observe different types of information such as different data types, data ranges, data units, string descriptions, and other proprietary metadata contained in or surrounding the semantic data model. Examples disclosed herein enable a person that is familiar with subject matter of a particular aspect of a system (e.g., an HMI aspect, a control system logic aspect, an edge aspect implemented in, for example, a Python script, or any other aspect) to automatically generate other aspects as part of a single semantic data model for that system such as an HMI aspect template, a control aspect template, an edge aspect template (e.g., a Python script), or any other aspect template that will use that single semantic data model for various input and output data sources.

In some examples, a semantic data model template can be associated with metadata such as author, last modified date, color, etc. In some examples, the metadata can include performance test results. For example, if an algorithm has an execution time measurement available in the metadata, there may be value in only accepting updates that decrease the execution time automatically. By including such an update in the metadata, it could be used to increase the performance of the multi-aspect object.

Additional features enabled by examples disclosed herein include tracking updates to multi-aspect object templates and semantic data model templates, providing graphical views of changes to multi-aspect object templates and semantic data model templates, determining when a multi-aspect object template or a semantic data model template should be generated, and using tools to patch/update a local version of a multi-aspect object template or a semantic data model template stored in a local machine rather than obtaining an updated version of the multi-aspect object template or the semantic data model template from, for example, cloud storage.

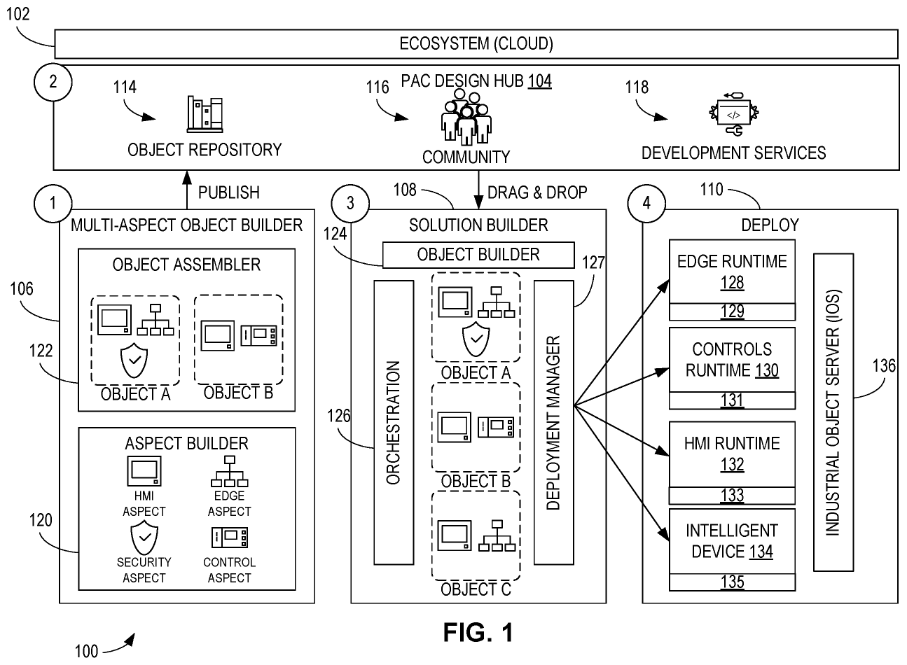

FIG. 1 is an example environment 100 to implement multi-aspect objects for distributed control systems. The environment 100 includes an example ecosystem 102 which may be implemented as a cloud-based system or as any other suitable network-based system. The environment 100 also includes a programmable automation control (PAC) design hub 104, an example multi-aspect object builder 106, an example solution builder 108, and an example deployment environment 110. The PAC design hub 104 is a development community collaboration platform in which software developers can publish, update, and/or access multi-aspect object templates, aspect templates, semantic data model templates, and other software. For example, the PAC design hub 104 allows developers to create and publish multi-aspect object templates of IndObject Type, browse and discover different published multi-aspect object templates, and/or perform concurrent development on multi-aspect object templates.

The PAC design hub 104, the multi-aspect object builder 106, the solution builder 108, the deployment environment 110, and components therein of FIG. 1 may be instantiated (e.g., creating an instance of, bring into being, materialize, implement, etc.) by programmable circuitry such as a Central Processor Unit (CPU) executing instructions. Additionally or alternatively, the PAC design hub 104, the multi-aspect object builder 106, the solution builder 108, the deployment environment 110, and components therein of FIG. 1 may be instantiated (e.g., creating an instance of, bring into being, materialize, implement, etc.) by (i) one or more Application Specific Integrated Circuits (ASICs) and/or (ii) one or more Field Programmable Gate Arrays (FPGAs). It should be understood that some or all of the circuitry of FIG. 1 may be instantiated at the same or different times. Moreover, in some examples, some or all of the circuitry of FIG. 1 may be implemented by microprocessor circuitry executing instructions and/or FPGA circuitry performing operations to implement one or more virtual machines and/or containers.

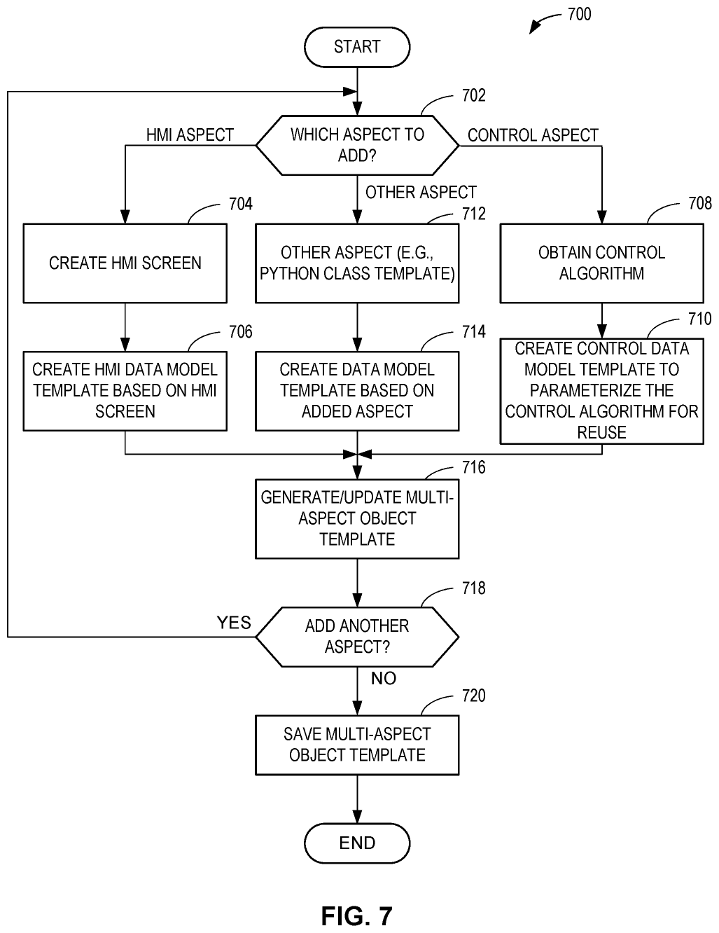

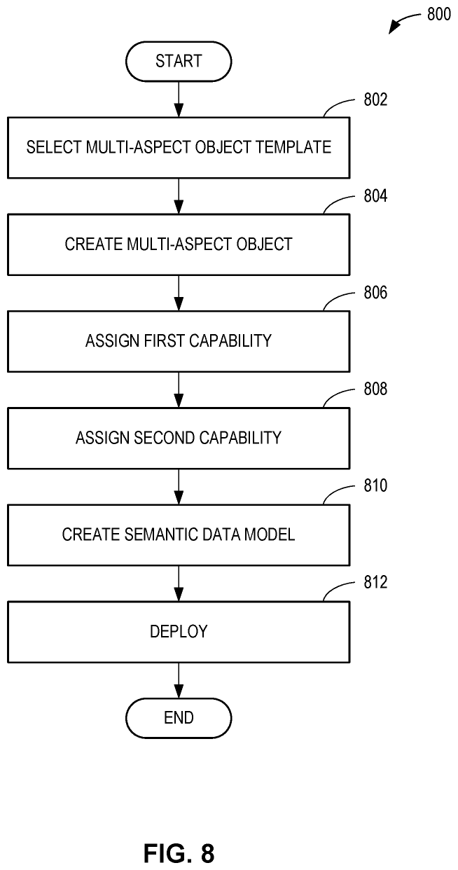

The PAC design hub 104, the multi-aspect object builder 106, the solution builder 108, the deployment environment 110, and components therein of FIG. 1 are structures. Such structures may implement means for performing corresponding disclosed functions. Examples of such functions are described below in connection with corresponding ones of the PAC design hub 104, the multi-aspect object builder 106, the solution builder 108, the deployment environment 110, and components therein and in connection with the flowcharts of FIGS. 7 and 8.

The PAC design hub 104 includes an example object repository 114, an example community interface 116, and example development services 118. The object repository 114 may be implemented using storage in which multi-aspect object templates, aspect templates, and semantic data model templates are stored. The community interface 116 may be implemented using a web-based interface (e.g., a web app, a web page, etc.) accessible by client devices through which software developers can view and select multi-aspect object templates, aspect templates, semantic data model templates, and/or other software published in the object repository 114. The development services 118 include tools such as code libraries, reference documents, programming manuals, articles, forums, etc. that can be accessed by software developers to facilitate development of multi-aspect object templates, aspect templates, and/or semantic data model templates.

The multi-aspect object builder 106 is provided to build multi-aspect object templates independent of physical equipment (e.g., hardware, controllers, field devices, etc.). The multi-aspect object builder 106 may be part of an IDE that executes on a computer and is accessible by developers. The developers provide user input via the computer to interact with the multi-aspect object builder 106. The multi-aspect object builder 106 includes an example aspect builder 120 and an example object assembler 122. The aspect builder 120 is provided to build aspect templates for use in creating multi-aspect object templates. As noted above, an aspect is a capability. As such, when a developer provides user input to the aspect builder 120 to create and configure an aspect template for a multi-aspect object template, the aspect builder 120 creates a capability that a resulting multi-aspect object will be able to perform when deployed. For example, in response to user input from a developer, the aspect builder 120 configures an aspect template (e.g., configure properties or attributes of an aspect) to operate in a particular way that is suitable for a particular purpose in a distributed control system. Example aspects shown in FIG. 1 that may be built using the aspect builder 120 include HMI aspects, edge aspects, security aspects, and control aspects. In other examples, the aspect builder 120 may be used to build any other suitable aspect templates in addition to or instead of the example aspects shown in FIG. 1.

In example FIG. 1, when the aspect builder 120 creates an aspect template, it configures attribute values, property values, and/or other parameter values that are then reusable to create and configure other aspects. For example, when the aspect builder 120 creates a control aspect template, the aspect builder 120 configures input and output ports and other data structures associated with the control aspect template. A control aspect instantiated based on that control aspect template uses such configuration during deployment to control corresponding physical equipment in a distributed control process. In addition, the configuration information and/or data structure(s) of the control aspect template is reusable during a design phase to enhance the development of another aspect template such as an HMI aspect template. That is, the configuration information and/or data structure(s) can be inherited into the HMI aspect template to configure functionality that displays information corresponding to the physical equipment. In this manner, when the aspect builder 120 creates and configures aspect templates, it implicitly creates configuration settings for other aspect templates that are subsequently created. That is, development of a new aspect template for a multi-aspect object template does not need to start from a clean slate but can borrow or inherit configuration information from a previously created aspect template for the same multi-aspect object. Such reusability of configuration information when developing aspect templates decreases the amount of code development needed from a developer when interacting with the aspect builder 120 to create aspect templates for a multi-aspect object template.

The object assembler 122 is provided to create multi-aspect object templates of industrial object type (IndObject Type). For example, the object assembler 122 accesses one or more aspect templates configured by the aspect builder 120 and adds the one or more aspect templates in a multi-aspect object template. The object assembler 122 can include any combination of aspects in a multi-aspect object template. In some examples, the object assembler 122 starts a multi-aspect object template anew by creating a new multi-aspect object template project to which a developer can add the first aspect template and any additional aspect templates. In other examples, the object assembler 122 obtains a previously created multi-aspect object template and updates aspect templates previously added to the multi-aspect object template, removes previously added aspect templates, and/or updates previously added aspect templates in the multi-aspect object template. After the object assembler 122 creates a multi-aspect object template, the multi-aspect object builder 106 can publish the multi-aspect object template to the object repository 114.

The solution builder 108 may be part of an IDE and is a low-code environment that executes on a computer and is accessible by developers to build control system applications (e.g., solutions) that include one or more multi-aspect objects. For example, by using templates published in the object repository 114 to instantiate and integrate aspects and multi-aspect objects of IndObject Type, the solution builder 108 reduces the amount of code that needs to be developed by a developer to create multi-aspect objects. The solution builder 108 may be used to implement aspects and multi-aspect objects according to a hierarchical organization. For example, multi-aspect object templates may be available to select for devices at a lowest level, and they can be hierarchically aggregated up to represent an entire manufacturing facility or distributed control system. As such, the solution builder 108 may create a multi-aspect object based on a multi-aspect object template for system-level manufacturing facility control, create another multi-aspect object based on a multi-aspect object template for unit control, and create another multi-aspect object based on a multi-aspect object template for physical equipment control. The solution builder 108 can hierarchically aggregate these multi-aspect objects to create more complex control and more complex representations of physical equipment in a manufacturing facility or distributed control system.

The solution builder 108 is coupled to the PAC design hub 104 via the community interface 116 of the PAC design hub 104. For example, the solution builder 108 may be implemented in a workstation or computer that is connected to the community interface 116 via one or more networks. A developer can interact with the solution builder 108 via the workstation to search multi-aspect object templates stored in the object repository 114 of the PAC design hub 104. The search may be based on one or more criteria specified by the developer. Based on selection input from the developer, the solution builder 108 retrieves or downloads one or more multi-aspect object templates from the object repository 114 to add to a control system application. In some examples, the workstation running the solution builder 108 can present a graphical user interface of the PAC design hub 104 in the form of a file repository window and the developer may use a drag-and-drop type of selection to move one or more multi-aspect objects from the PAC design hub 104 to a control system application project open in the solution builder 108. Each multi-aspect object template includes configuration information for its different aspects to enable self-assembly of a multi-aspect object based on that template. That is, the solution builder 108 can use the configuration information in a selected multi-aspect object template to assemble or build a multi-aspect object with little or no input from a developer. However, a developer may provide input to the solution builder 108 if the developer elects to customize any part of the multi-aspect object.

The solution builder 108 includes an example object builder 124, an example orchestration manager 126, and an example deployment manager 127. The object builder 124 generates or instantiates multi-aspect objects based on multi-aspect object templates retrieved form the object repository 114. For example, the object builder 124 creates and assigns aspects to a multi-aspect object based on aspects defined in the multi-aspect object template. In some examples, the object builder 124 receives user input from developers to customize the aspects of the multi-aspect object for use in particular distributed control systems.

The orchestration manager 126 is provided to coordinate the collaboration of different multi-aspect objects to realize a control strategy. For example, the orchestration manager 126 may be implemented as a graphical tool to program interactions and orders of execution of the multi-aspect objects. A developer may use the orchestration manager 126 to create multi-aspect object instances of multiple-aspect IndObject Types, parameterize them, and create control logic to coordinate the interactions of the multiple-aspect objects. Control logic in a control aspect controls one physical field device based on an operating state of another field device. For example, to create control logic for a water tank level control system, a developer may use the orchestration manager 126 to configure I/O definitions in a control aspect to communicate with a fluid level sensor of a tank, a valve, and a pump. Using such I/O definitions, the control aspect can obtain a tank fluid level from a sensor, configure a valve to open based on a low fluid level status from the sensor, and configure a pump to run based on an open state of the valve. After a multi-aspect object is instantiated, the object builder 124 creates an instance of that multi-aspect object and binds aspects to their runtime platforms (e.g., the runtime platforms 128, 130, 132, 134) in the deployment environment 110.

In some examples, a developer (e.g., a power user) may elect to not use one or more development features of the solution builder 108. In such examples, the developer may retrieve a multi-aspect object template from the object repository 114, use the multi-aspect object template to directly code a multi-aspect object, and send the resulting multi-aspect object do the deployment manager 127.

When a control application is ready for deployment, the deployment manager 127 automatically deploys the multi-aspect objects of the control application into the deployment environment 110. For example, the deployment manager 127 deploys different aspects of the multi-aspect objects to execute on corresponding runtime platforms (e.g., corresponding ones of the runtime platforms 128, 130, 132, 134 of the deployment environment 110) to interact with corresponding physical equipment in a distributed control system.

The deployment manager 127 deploys the semantic data model to share data across different aspects of a multi-aspect object. That is, the semantic data model is a communication conduit through which the different aspects of the corresponding multi-aspect object share information with one another. The deployment manager 127 provides event configurations in the semantic data model and/or in aspects of the multi-aspect object to implement eventing. Such eventing can be used to synchronize operations across the aspects of the multi-aspect object. In this manner, if a control aspect is changed, it can raise an event that would allow the other aspects of the multi-aspect object to synchronize their behavior automatically.

To ensure that aspects across multi-aspect objects can communicate with one another, the semantic data model is configured to perform data format conversions to convert data formats from the different aspects and/or from other data sources to a normalized or uniform data format understandable across the aspects. Such data format conversions may be performed by the semantic data model using OPC UA or any other data unification process. In any case, by normalizing data formatting or making data formatting uniform, multi-aspect objects disclosed herein may be implemented without using integration layers in which manual mapping between data needs to be performed. Instead, through normalizing data formatting or making data formatting uniform in semantic data models throughout a distributed control system, data from a manufacturing facility floor can be propagated all the way up to cloud storage or to any other layer of an automation hierarchy automatically without integration layers or manual data mapping from one data format to another (e.g., translate from one protocol in a manufacturing facility to another protocol in cloud storage). In this manner, semantic data models keep the different aspects of multi-aspect objects synchronized with one another and provide consistent representation of information across the aspects. For example, data from a PLC (e.g., a control aspect), data at an HMI screen (e.g., an HMI aspect), and data from an edge application (e.g., an edge aspect) can be reviewed using the same data format.

During a development phase, a developer may access the development services 118 in the PAC design hub 104 through the community interface 116. For example, a developer may access code libraries, reference documents, programming manuals, articles, forums, etc. In some examples, the development services 118 may provide real-time or substantially real-time chat sessions with artificial intelligent (AI) based systems that guide users on how to use multi-aspect objects. In such examples, a developer may access chat interfaces in the development services 118.

The deployment environment 110 executes aspects of multi-aspect objects in different runtime platforms. The deployment environment 110 may represent a distributed control system (e.g., a chemical process control system, petroleum process control system, a semiconductor manufacturing process control system, a product manufacturing process control system, a food manufacturing process control system, etc.) that includes one or more centralized process controllers communicatively coupled to at least one host or operator workstation and to one or more field devices via analog, digital, or combined analog/digital buses. As ushed herein, a field device is physical equipment that can be located in a distributed control system to perform an operation in the distributed control system and/or to collect process data in the distributed control system. For example, field devices in the deployment environment 110 may include pumps, valves, valve positioners, compressors, switches, sensors (e.g., temperature sensors, pressure sensors, flow rate sensors, etc.), transmitters, etc. that perform corresponding functions in the distributed control system such as moving materials, opening valves, closing valves, collecting sensor data, etc.

Some field devices in the deployment environment 110 are intelligent field devices that include programmable microprocessors to perform more complex operations and data processing than merely controlling field device operation and collecting data. For example, an intelligent field device may be programmed to autonomously filter data, or take different actions in response to patterns, trends, or other findings in collected data by the intelligent field device. In examples disclosed herein, intelligent device aspects may be added to a multi-aspect object template to program and interact with such intelligent devices.

In example FIG. 1, the deployment environment 110 includes an example edge runtime platform 128, an example controls runtime platform 130, an example HMI runtime platform 132, and an example intelligent device runtime platform 134. Each runtime platform 128, 130, 132, 134 executes a corresponding type of aspect of multi-aspect objects. For example, the edge runtime platform 128 executes edge aspects of the multi-aspect objects, the controls runtime platform 130 executes control aspects of multi-aspect objects, the HMI runtime platform 132 executes HMI aspects of multi-aspect objects, and the intelligent device platform 134 executes security aspects of multi-aspect objects.

Each runtime platform 128, 130, 132, 134 can be instantiated on a corresponding hardware platform which may be connected to physical equipment in a distributed control system. In this manner, controllers implement functionality programmed into the multi-aspect objects running on the different runtime platforms 128, 130, 132, 134 to control and/or monitor corresponding physical equipment (e.g., field devices). For example, a multi-aspect object running on a controller receives signals indicative of process measurements made by the physical equipment and/or other information pertaining to the physical equipment. The multi-aspect object uses this information to implement a control routine and to generate control signals that are sent over buses or other communication lines to the physical equipment to control operations of a process. In some examples, the runtime platforms 128, 130, 132, 134 include data servers to make information from the physical equipment and the controllers accessible by one or more applications executed by the operator workstation. This enables an operator to perform desired functions with respect to the process, such as viewing the current state of the process, modifying the operation of the process, etc. In some examples, the information from the physical equipment and the controllers may be used by the operator or a developer to modify a multi-aspect object template in the multi-aspect object builder 106 and/or to modify a control system application in the solution builder 108 to achieve a new process target (e.g., a different material formulation, a different product quality, etc.) or to adjust a current process that does not satisfy a current process target.

In example FIG. 1, the edge runtime platform 128 runs on an example industrial computer 129, the controls runtime platform 130 runs on an example physical deterministic controller 131, the HMI runtime platform 132 runs on an example operating system (OS)-based server 133, the intelligent device runtime platform 134 runs on an example intelligent device 135. The industrial computer 129 may be implemented by, for example, an industrial personal computer (PC) or any other suitable edge device. The physical deterministic controller 131 may be implemented by, for example, a programmable logic controller (PLC). The OS-based server 133 may be implemented by, for example, a server running a Microsoft Windows®OS or any other OS that can be used to display graphical user interfaces.

The deployment environment 110 also includes an example industrial object server (IOS) 136. The industrial object server 136 is provided to aggregate data from different aspects in the runtime platforms 128, 130, 132, 134 to, for example, provide a comprehensive set of data objects (e.g., data objects that include process control information collected from the different aspects) to higher-level client devices. For example, runtime platforms may communicate with the industrial object server 136 to monitor processes and/or physical equipment in a distributed control system. Using the industrial object server 136, client devices may access GUIs to monitor data collected from the physical equipment. In some examples, the industrial object server 136 processes collected data to generate aggregated data or enriched information for presentation via the GUIs. The industrial object server 136 also receives configuration information from connected client devices to update aspects executing on the runtime platforms 128, 130, 132, 134. In this manner, a client device may adjust operations or functionality of different aspects of multi-aspect objects based on analyses of collected monitoring data.

While an example manner of implementing the PAC design hub 104, the multi-aspect object builder 106, the solution builder 108, the deployment environment 110, and components therein is illustrated in FIG. 1, one or more of the elements, processes, and/or devices illustrated in FIG. 1 may be combined, divided, re-arranged, omitted, eliminated, and/or implemented in any other way. Further, the PAC design hub 104, the multi-aspect object builder 106, the solution builder 108, the deployment environment 110, and/or components therein of FIG. 1, may be implemented by hardware alone or by hardware in combination with software and/or firmware. Thus, for example, any of the PAC design hub 104, the multi-aspect object builder 106, the solution builder 108, the deployment environment 110, and/or components therein could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example PAC design hub 104, the multi-aspect object builder 106, the solution builder 108, the deployment environment 110, and components therein of FIG. 1 may include one or more elements, processes, and/or devices in addition to, or instead of, those illustrated in FIG. 1, and/or may include more than one of any or all of the illustrated elements, processes and devices.

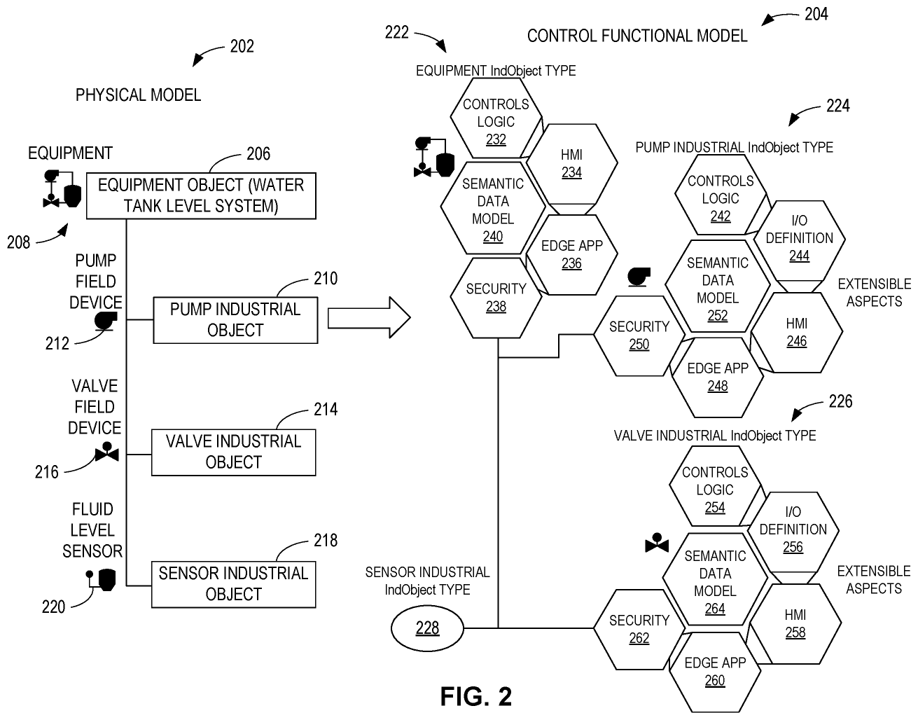

FIG. 2 is an illustration of a physical model 202 representative of physical equipment for a physical water tank level system in a facility and a corresponding control functional model 204 including multi-aspect objects to interact with the physical equipment in the physical model 202. The physical model 202 includes physical equipment in an example physical water tank level system 208, including an example pump 212 (e.g., a pump field device), an example valve 216 (e.g., a valve field device), and an example fluid level sensor 220 (e.g., a sensor field device). Although the pump 212, the valve 216, and the sensor 220 are shown, examples disclosed herein may be implemented with any other physical equipment in addition to or instead of one or more of the pump 212, the valve 216, and the sensor 220. In some examples the physical equipment includes controllers (e.g., hardware controllers) to control devices such as the pump 212, the valve 216, the sensor 220, or any other devices.

In examples disclosed herein, there are lower-level objects that correspond directly to individual physical devices and higher-level objects that represent systems of devices. In example FIG. 2, an example equipment object 206 is a higher-level object that is instantiated for the physical water tank level system 208. Lower-level objects represented in FIG. 2 are an example pump industrial object 210 that is instantiated for the pump 212, an example valve industrial object 214 that is instantiated for the valve 216, and an example sensor industrial object 218 that is instantiated for the fluid level sensor 220. The control functional model 204 includes an example equipment multi-aspect IndObject Type 222, an example pump industrial multi-aspect IndObject Type 224, an example valve industrial multi-aspect IndObject Type 226, and an example sensor industrial multi-aspect IndObject Type 228.

The equipment multi-aspect IndObject Type 222 is used to instantiate the equipment object 206 of the physical water tank level system 208. The example pump industrial multi-aspect IndObject Type 224 is used to instantiate the pump industrial object 210 of the pump 212 in the physical model 202. The valve industrial multi-aspect IndObject Type 226 is used to instantiate the valve industrial object 214 of the valve 216 in the physical model 202. The sensor industrial multi-aspect IndObject Type 228 is used to instantiate the sensor industrial object 218 of the fluid level sensor 220.

In example FIG. 2, the equipment multi-aspect IndObject Type 222, the pump industrial multi-aspect IndObject Type 224, the valve industrial multi-aspect IndObject Type 226, and the sensor industrial multi-aspect IndObject Type 228 are part of a control system application developed in the solution builder 108 (FIG. 1) and deployed in the deployment environment 110 (FIG. 1) to control and/or monitor the physical water tank level system 208, the pump 212, the valve 216, and the fluid level sensor 220 in the physical model 202. Each of the equipment multi-aspect IndObject Type 222, the pump industrial multi-aspect IndObject Type 224, and the valve industrial multi-aspect IndObject Type 226 is shown with a number of aspects. However, the equipment multi-aspect IndObject Type 222, the pump industrial multi-aspect IndObject Type 224, and the valve industrial multi-aspect IndObject Type 226 are extensible to include any other suitable aspects in addition to or instead of the aspects shown in FIG. 2. Other example aspects that may be added can include alarm management functionality, I/O definitions, performance tuning functionality, etc. In addition, the equipment multi-aspect IndObject Type 222, the pump industrial multi-aspect IndObject Type 224, and the valve industrial multi-aspect IndObject Type 226 may be implemented using fewer aspects than shown in FIG. 2. In addition, the sensor industrial multi-aspect IndObject Type 228 also includes multiple aspects. For purposes of simplicity, those aspects are not shown. However, the aspects of the sensor industrial multi-aspect IndObject Type 228 may be configured using the aspect builder 120 (FIG. 1) for purposes of obtaining readings from the fluid level sensor 220.

In example FIG. 2, the equipment object 206 is instantiated in hardware to cause the underlying hardware (e.g., the industrial computer 129 hosting the edge runtime platform 128, the physical deterministic controller 131 hosting the controls runtime platform 130, the operating system (OS)-based server 133 hosting the HMI runtime platform 132, and/or the intelligent device 135 hosting the intelligent device runtime platform 134 of FIG. 1) to execute functionality programmed into the equipment multi-aspect IndObject Type 222. For example, based on functionality programmed in the equipment multi-aspect IndObject Type 222, the equipment object 206 is implemented as a higher-level object. As a higher-level object, the equipment object 206 causes a controller (e.g., the physical deterministic controller 131) to orchestrate coordinated operations of physical equipment in a control system to implement a process in a synchronous or asynchronous fashion to achieve a desired result. Higher-level object functionality (e.g., functionality in the equipment object 206) may be triggered manually in response to manipulation of a user interface that corresponds to the higher-level object, or by rules dependent upon defined states of one or more lower-level objects. In addition, higher-level objects may themselves present states (e.g., based on similar rules) that may be monitored and acted upon in accordance to rules defined by yet higher-level objects corresponding to higher-level systems.

For example, in the physical water tank level system 208, the pump industrial object 210, the valve industrial object 214, and the sensor industrial object 218 are lower-level objects. As such, the equipment object 206 (e.g., a higher-level object) causes its corresponding controller (e.g., the physical deterministic controller 131) to enable or disable the pump 212 and close or open the valve 216 in coordinated fashion based on sensor data collected from the fluid level sensor 220. In such example, when the controller corresponding to the equipment object 206 receives sensor data from the fluid level sensor 220 (corresponding to the lower-level sensor industrial object 218) indicating that a water level is below a minimum threshold, the equipment object 206 (e.g., a higher-level object) causes the controller to send an instructions to the valve industrial object 214 (e.g., a lower-level object) and the pump industrial object 210 (e.g., a lower-level object). The instruction to the valve industrial object 214 causes a controller corresponding to the valve industrial object 214 to open the valve 216. The instruction to the pump industrial object 210 causes a controller corresponding to the pump industrial object 210 to enable the pump 212 to move water into a tank. Also in such example, when the controller corresponding to the equipment object 206 receives sensor data from the fluid level sensor 220 indicating that a water level is above a maximum threshold, the controller corresponding to the equipment object 206 also sends instructions to the pump industrial object 210 and the valve industrial object 214. The instruction to the pump industrial object 210 causes the controller corresponding to the pump industrial object 210 to disable the pump 212. The instruction to the valve industrial object 214 causes the controller corresponding to the valve industrial object 214 to close the valve 216. To implement such functionality, the equipment multi-aspect IndObject Type 222 includes an example control aspect 232 (e.g., controls logic), an example HMI aspect 234, an example edge aspect 236 (e.g., an edge app), an example security aspect 238, and an example semantic data model 240.

The control aspect 232 is provided to control physical equipment. For example, the control aspect 232 runs on a controls runtime platform such as the controls runtime platform 130 executed by the physical deterministic controller 131 of FIG. 1 to control physical equipment of the physical water tank level system 208. The HMI aspect 234 runs on an HMI runtime platform such as the HMI runtime platform 132 executed by the OS-based server 133 of FIG. 1 to provide user interfaces (e.g., GUIs) to monitor and operate the physical equipment of the physical water tank level system 208. The edge aspect 236 runs on an edge runtime platform such as the edge runtime platform 128 executed by the industrial computer 129 of FIG. 1 to analyze field devices in the physical water tank level system 208 based on collected data to gain insights and generate actions specifying how to configure the physical equipment in the physical water tank level system 208 (e.g., how to optimize a configuration of and/or communication between the physical equipment).

The security aspect 238 runs on a security runtime platform or an intelligent device runtime platform such as the intelligent device runtime platform 134 executed by the intelligent device 135 of FIG. 1. The security aspect 238 includes access levels associated with a semantic data model (e.g., read-only access, read/write access) and roles. As used herein, a role includes one or more privilege definitions. A privilege defines an access authorization to access data, a control interface, a configuration interface, etc. A role is assigned to a user to associate that user with one or more privileges defined in the role. Example roles include an engineer role and an operator role. A privilege level defined in an engineer role may allow an engineer user to change tuning gain in an operation. A privilege level defined in an operator role may restrict an operator user to only start and stop the operation.

The semantic data model 240 is provided to convert and share data between the control aspect 232, the HMI aspect 234, the edge aspect 236, and the security aspect 238 of the equipment multi-aspect IndObject Type 222. The semantic data model 240 overcomes challenges that arise when one or more of the aspects 232, 234, 236, 238 generates data in a format different from what others of the aspects 232, 234, 236, 238 can read. To enable different ones of the aspects 234 to understand the shared data, the semantic data model 240 converts, translates, or normalizes data from each aspect 232, 234, 236, 238 into a uniform format understandable by all of the aspects 232, 234, 236, 238. The semantic data model 240 may be implemented using any suitable format translation interface that can receive data in multiple formats and convert the data to a single format compatible with all of the aspects 232, 234, 236, 238 of the equipment multi-aspect IndObject Type 222. An example data model that may be used to implement the format translation interface of the semantic data model 240 is an Open Platform Communications Unified Architecture (OPC UA) data model. As such, data that originated from an OPC UA server and is consumed by an OPC UA client can be processed and/or served up to other aspects in a manner that allows different aspects across one or more multi-aspect objects to talk to one another using a normalized or uniform data format. By providing the semantic data model 240, aspects can be added to the equipment multi-aspect IndObject Type 222 without needing to re-program how such aspects format data.

The data shared by the semantic data model 240 includes monitoring data collected from monitoring the physical water tank level system 208, input data received through user input via the HMI aspect 234, control actions from the edge aspect 236 associated with controlling the physical water tank level system 208, and indications of state from the control aspect 232 to the other aspects. An indication of state is an operation status of how physical equipment is operating (e.g., based on a changed configuration such as a changed setpoint). An indication of state could be represented as a reduction in error attributable to a control action provided by the edge aspect 236 or could be represented using any other suitable information. A control action from the edge aspect 236, an indication of state from the control aspect 232, and/or monitoring data may be shared by the semantic data model 240 with the HMI aspect 234 to display via a user interface for review by a user. The control action may also be shared by the semantic data model 240 with the control aspect 232 to cause the equipment object 206 to implement the control action.

In example FIG. 2, the pump industrial object 210 is an object instantiation of the pump industrial multi-aspect IndObject Type 224. For example, based on the pump industrial multi-aspect IndObject Type 224, the pump industrial object 210 controls functionality of the pump 212 and/or collects monitoring data associated with the pump 212. To implement such functionality, the pump industrial multi-aspect IndObject Type 224 includes an example control aspect 242, an example I/O definition aspect 244, an example HMI aspect 246, an example edge aspect 248, an example security aspect 250, and an example semantic data model 252.

The control aspect 242 runs on a controls runtime platform such as the controls runtime platform 130 executed by the physical deterministic controller 131 of FIG. 1 to control the pump 212. The I/O definition aspect 244 runs on an I/O runtime platform to configure input and output ports of the pump 212. The HMI aspect 246 runs on an HMI runtime platform such as the HMI runtime platform 132 executed by the OS-based server 133 of FIG. 1 to provide user interfaces (e.g., GUIs) to monitor and operate the pump 212. The edge aspect 248 runs on an edge runtime platform such as the edge runtime platform 128 executed by the industrial computer 129 of FIG. 1 to analyze functionality of the pump 212 based on collected data associated with operation of the pump 212. In this manner, the edge aspect 248 gains insights and generates actions specifying how to configure the pump 212 (e.g., how to optimize a configuration of pump 212).

The security aspect 250 runs on a security runtime platform or an intelligent device runtime platform such as the intelligent device runtime platform 134 executed by the intelligent device 135 of FIG. 1 to authorize or prevent accesses to the pump 212 based on user privileges defined in roles. The semantic data model 252 functions in a substantially similar way to the semantic data model 240 and is provided to convert and share data between the control aspect 242, the I/O definition aspect 244, the HMI aspect 246, the edge aspect 248, and the security aspect 250.

In example FIG. 2, the valve industrial object 214 is an object instantiation of the valve industrial multi-aspect IndObject Type 226. For example, based on the valve industrial multi-aspect IndObject Type 226, the valve industrial object 214 controls functionality of the valve 216 and/or collects monitoring data associated with the valve 216. To implement such functionality, the valve industrial multi-aspect IndObject Type 226 includes an example control aspect 254, an example I/O definition aspect 256, an example HMI aspect 258, an example edge aspect 260, an example security aspect 262, and an example semantic data model 264.

The control aspect 254 runs on a controls runtime platform such as the controls runtime platform 130 executed by the physical deterministic controller 131 of FIG. 1 to control the valve 216. The I/O definition aspect 256 runs on an I/O runtime platform to configure input and output ports of the valve 216. The HMI aspect 258 runs on an HMI runtime platform such as the HMI runtime platform 132 executed by the OS-based server 133 of FIG. 1 to provide user interfaces (e.g., GUIs) to monitor and operate the valve 216. The edge aspect 260 runs on an edge runtime platform such as the edge runtime platform 128 executed by the industrial computer 129 of FIG. 1 to analyze functionality of the valve 216 based on collected data associated with operation of the valve 216. In this manner, the edge aspect 260 gains insights and generates actions specifying how to configure the valve 216 (e.g., how to optimize a configuration of valve 216).

The security aspect 262 runs on a security runtime platform or an intelligent device runtime platform such as the intelligent device runtime platform 134 executed by the intelligent device 135 of FIG. 1 to authorize or prevent accesses to the valve 216 based on user privileges defined in roles. The semantic data model 264 functions in a substantially similar way to the semantic data model 240 and the sematic data model 252 and is provided to convert and share data between the control aspect 254, the I/O definition aspect 256, the HMI aspect 258, the edge aspect 260, and the security aspect 262.

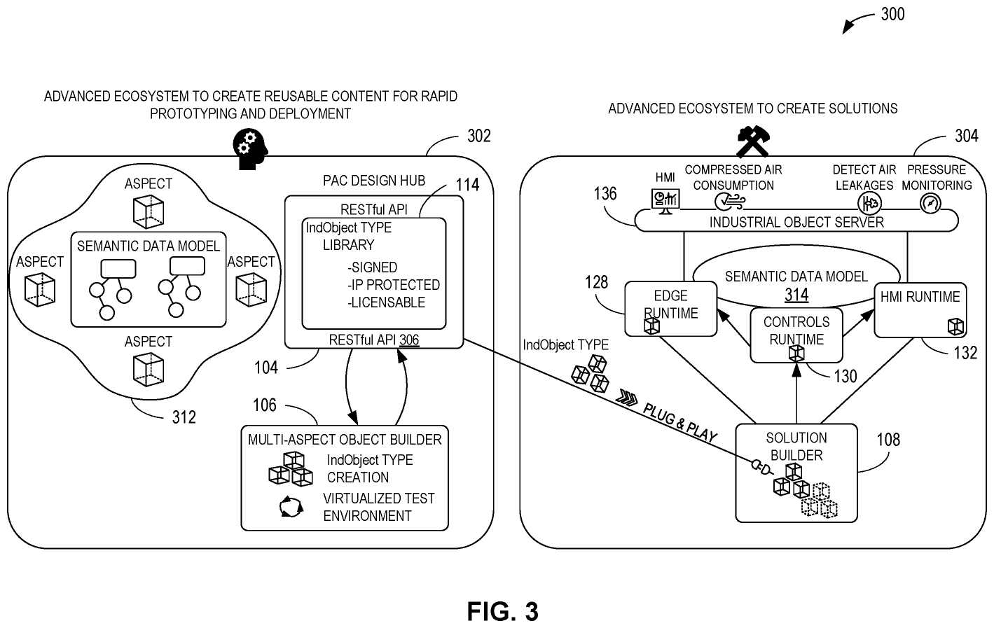

FIG. 3 is an example development environment 300 to generate the industrial multi-aspect IndObject Types 222, 224, 226, 228 of FIG. 2 and deploy corresponding industrial objects. The development environment 300 includes an example reusable content creation ecosystem 302 and an example solutions creation ecosystem 304. The reusable content creation ecosystem 302 includes the PAC design hub 104 and the multi-aspect object builder 106 of FIG. 1 to create and publish aspect templates, semantic data model templates, and multi-aspect object templates. The PAC design hub 104 includes an example REpresentational State Transfer (REST) API 306 to communicate with the multi-aspect object builder 106, and the solution builder 108 of FIG. 1. The REST or RESTful API 306 is an application program interface (API) that uses hypertext transfer protocol (HTTP) requests to access and use data.

The PAC design hub 104 includes the object repository 114 of FIG. 1, also referred to as an IndObject Type library. The object repository 114 stores multi-aspect object templates of IndObject Type, aspect templates, and semantic data model templates published by developers for subsequent access by the same developers or other developers. To protect published contents, the object repository 114 employs signatures to authenticate such content. This reduces or eliminates the likelihood that published content can be modified in harmful ways. The object repository 114 also protects intellectual property (IP) interests in the published content by implementing access authorization safeguards that track user permissions for the published contents and verify such permissions for users that request access to the contents. As such, by enforcing access permission verifications, the object repository 114 enables published content to be licensable or commercially monetizable by owners.

The multi-aspect object builder 106 is an application program that communicates with the object repository 114 of the PAC design hub 104 via the RESTful API 306 to publish multi-aspect object templates, aspect templates, and data model templates and to access published multi-aspect object templates, aspect templates, and data model templates for subsequent development. For example, the multi-aspect object builder 106 may build a multi-aspect object template 312 that includes an example semantic data model template and corresponding aspect templates based on user input from a developer. The multi-aspect object template 312 provides a general framework of aspect structures and semantic data model interoperability. An example process to build such a multi-aspect object template 312 is described below in connection with the flowchart of FIG. 7. When complete, the multi-aspect object builder 106 uses an API call to publish the multi-aspect object template 312 to the object repository 114 via the RESTful API 306.

A developer may subsequently retrieve the multi-aspect object template 312 and its pre-populated aspect templates and semantic data model template from the object repository 114. For example, the developer may select the multi-aspect object template 312 based on it suiting the needs of that developer and providing sufficient flexibility for the developer to customize portions of aspects based on the aspect templates and portions of a semantic data model based on the semantic data model template. In such example, the developer uses the multi-aspect object template 312 to generate a multi-aspect object for a particular use with particular user equipment. As such, since the multi-aspect object template 312 is not tied to a particular configuration, such template may be re-usable by many developers and offer customizable flexibility for use with many types of controllers and field devices to suit an array of purposes.

In some examples, the multi-aspect object builder 106 may also generate aspect templates based on developer input and publish the aspect templates to the object repository 114 separate from multi-aspect object templates. An aspect template may be used to provide a general framework for certain types of aspects to operate with particular controllers or types of controllers and/or with particular field devices or types of field devices in a distributed control system. In this manner, the aspect template can be generated once and published to the object repository 114 for subsequent access any number of times by the same developer or other developers for use in subsequently adding different aspects to multi-aspect object templates.

In some examples, the multi-aspect object builder 106 may also generate semantic data model templates based on developer input and publish the semantic data model templates to the object repository 114 separate from multi-aspect object templates. A semantic data model template may be used to provide a general framework for sharing data across certain types of aspects. In this manner, the semantic data model template can be generated once and published to the object repository 114 for subsequent access any number of times by the same developer or other developers to incorporate in subsequent multi-aspect object templates. For example, the semantic data model template of the multi-aspect object template 312 may be based on a semantic data model template accessed by the multi-aspect object builder 106 from the object repository 114.

The solutions creation ecosystem 304 includes the solution builder 108 of FIG. 1. The solutions creation ecosystem 304 also includes the edge runtime platform 128, the controls runtime platform 130, the HMI runtime platform 132, and the industrial object server (IOS) 136 of the deployment environment 110 of FIG. 1. The solution builder 108 is an application program that communicates with the object repository 114 via the RESTful API 306. For example, the solution builder 108 can provide a user interface through which a user can view multi-aspect object templates (e.g., of IndObject Type) available in the object repository 114. Based on a user selection of a multi-aspect object template, the solution builder 108 can generate and send an API call to the RESTful API 306 to request access to the selected multi-aspect object template in the object repository 114.

In example FIG. 3, when retrieving a multi-aspect object template from the object repository 114, the solution builder 108 seamlessly incorporates a multi-aspect object based on the multi-aspect object template into a project. For example, the solution builder 108 uses configuration information or property values of multi-aspect object templates retrieved from the object repository 114 to create and incorporate corresponding multi-aspect objects in plug and play fashion into solutions. For example, the solution builder 108 can use the configuration information or property values of a multi-aspect object to bind aspects of the multi-aspect object with physical controllers and/or field devices of a distributed control system. The solution builder 108 can also use the configuration information or property values of the multi-aspect object to configure communication settings between the multi-aspect object and other multi-aspect objects.

The solution builder 108 deploys multi-aspect objects to run on different runtime platforms of the deployment environment 110. In example FIG. 3, the solution builder 108 deploys an edge aspect of a multi-aspect object to run on the edge runtime platform 128, deploys a controls aspect of the multi-aspect object to run on the controls runtime platform 130, and deploys an HMI aspect of the multi-aspect object to run on the HMI runtime platform 132. In addition, the solution builder 108 configures a semantic data model 314 of the multi-aspect object to communicate with the edge runtime platform 128, the controls runtime platform 130, and the HMI runtime platform 132 to convert and share data across the multiple aspects of the multi-aspect object.

The industrial object server 136 aggregates data associated with different aspects in the runtime platforms 128, 130, 132 for access by client devices. For example, the industrial object server 136 may aggregate the data to be presented via GUIs provided by an HMI aspect running on the HMI runtime platform 132. The GUIs can be used to provide access to configuration information, status information, and/or collected monitoring data associated with physical equipment in a distributed control system. For example, client devices receive and present the GUIs to allow users to monitor processes and/or physical equipment in the distributed control system. In example FIG. 3, such information pertains to compressed air consumption, air leakage detections, and pressure monitoring. However, any other suitable data may be aggregated by the industrial object server 136. The industrial object server 136 also receives configuration information from client devices to update aspects executing on the runtime platforms 128, 130, 132. In this manner, a client device may adjust operations or functionality of different aspects of multi-aspect objects based on analyses of collected monitoring data.

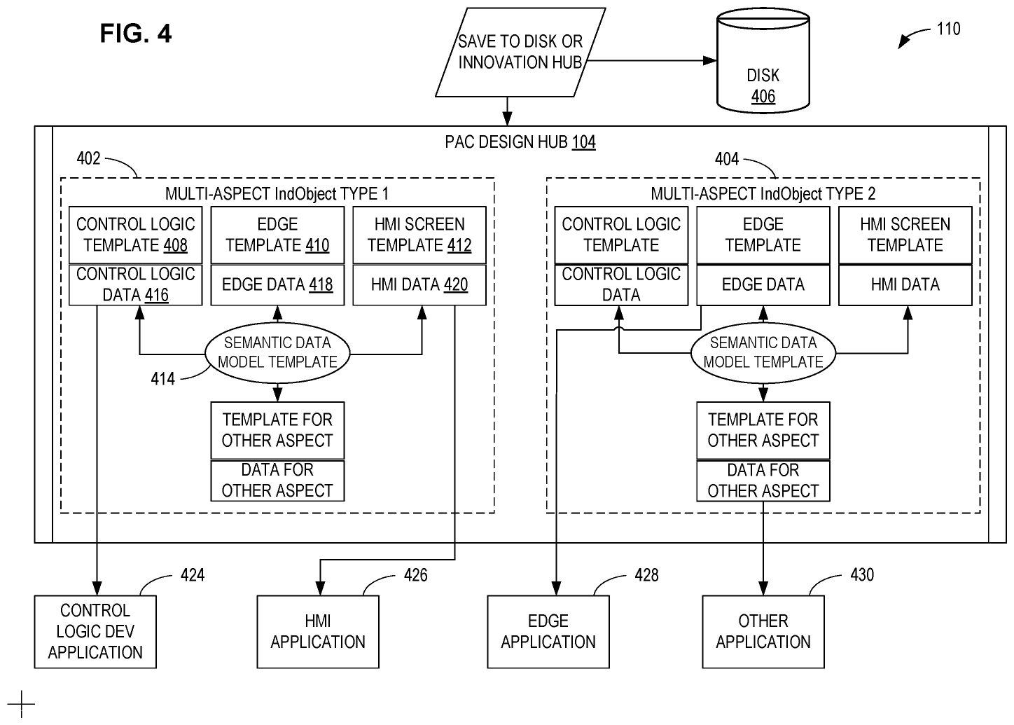

FIG. 4 illustrates example multi-aspect IndObject Types 402, 404 created based on the same multi-aspect object template published in the PAC design hub 104 of FIGS. 1 and 3. The multi-aspect IndObject Types 402, 404 may be used to instantiate corresponding industrial objects (e.g., the industrial objects 206, 210, 214, 218 of FIG. 2). For example, a multi-aspect object template (e.g., the multi-aspect object template 312 of FIG. 3) may be developed in the multi-aspect object builder 106 of FIGS. 1 and 3 and published to the object repository 114 (FIGS. 1 and 3) of the PAC design hub 104 for subsequent retrieval. Additionally or alternatively, multi-aspect object templates can be stored locally on a local disk 406 and retrieved from the local disk 406 to create the multi-aspect IndObject Types 402, 404.

The multi-aspect IndObject Type 402 is created based on a multi-aspect object template that includes an example control aspect template 408, an example edge aspect template 410, and an example HMI aspect template 412. The control aspect template 408 may be used to create a control aspect (e.g., the control aspect 232, the control aspect 242, or the control aspect 254 of FIG. 2). The edge aspect template 410 may be used to create an edge aspect (e.g., the edge aspect 236, the edge aspect 248, or the edge aspect 260 of FIG. 2). In some examples, the edge aspect template 410 may be implemented using Python class code. The HMI aspect template 412 may be used to create an HMI aspect (e.g., the HMI aspect 234, the HMI aspect 246, or the HMI aspect 258 of FIG. 2). Although particular aspect templates are shown for the multi-aspect IndObject Type 402, any other type of aspect template may be included in the multi-aspect IndObject Type 402 in addition to or instead of one or more of the aspect templates 408, 410, 412 shown.

The multi-aspect object template used to create the multi-aspect IndObject Type 402 also includes a semantic data model template 414 that may be used to create a semantic data model to receive, convert, and share data across the multiple aspects of the multi-aspect IndObject Type 402. In example FIG. 3, the semantic data model template 414 is configured with a general communications framework to access control logic data 416 from a control aspect, access edge data 418 from an edge aspect, and access HMI data 420 from an HMI aspect. The semantic data model template 414 is also configured with a general data conversion framework to convert or translate aspect data to a format that is compatible with all of the aspects of the multi-aspect IndObject Type 402.

The multi-aspect IndObject Type 404 is structured in substantially the same way as the multi-aspect IndObject Type 402 since they are based on the same multi-aspect object template. However, the multi-aspect IndObject Type 402 is shown in FIG. 4 as connecting a control aspect (e.g., corresponding to the control aspect template 408) to a control logic development application 424 and connecting an HMI aspect (e.g., corresponding to the HMI aspect template 412) to an HMI application 426, and the multi-aspect IndObject Type 404 is shown connecting an edge aspect to an edge application 428 and an “other” aspect to an “other” application 430. Such different connection configurations represent the versatility of a multi-aspect object template in the PAC design hub 104. That is, the flexible configurability of the multi-aspect object template used to create the multi-aspect IndObject Types 402, 404 enables it to be used to configure different functionality and connections. As such, the same multi-aspect object template can be used to create different multi-aspect IndObject Types with different configurations and for different uses.

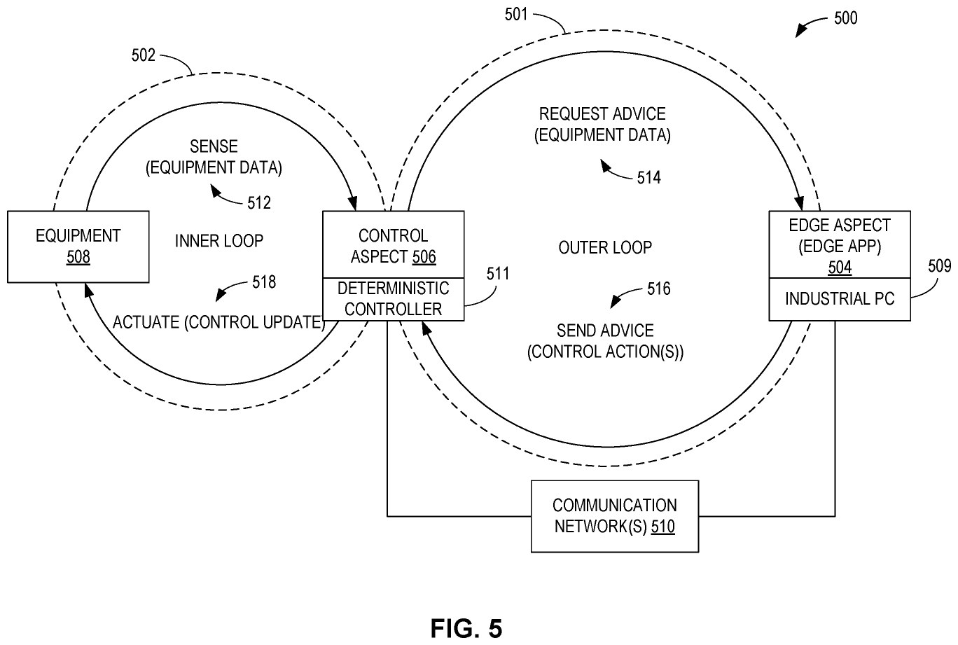

FIG. 5 is an example inner and outer control environment 500 implementable by an example edge aspect 504 of a multi-aspect IndObject Type (e.g., the equipment multi-aspect IndObject Type 222, the pump industrial multi-aspect IndObject Type 224, the valve industrial multi-aspect IndObject Type 226, the sensor industrial IndObject Type 228 of FIG. 2), an example control aspect 506, and example physical equipment 508. The inner and outer control environment 500 includes an example outer loop 501 and an example inner loop 502. The edge aspect 504 and the control aspect 506 are in communication with each other via one or more example communication network(s) 510 to form the outer loop 501. The control aspect 506 and the physical equipment 508 are in communication with each other to form the inner loop 502 via, for example, a bus or network (not shown).

The edge aspect 504 may be implemented by an edge application developed using Python script language or any other suitable programming language. In example FIG. 5, the edge aspect 504 runs on an industrial PC 509 (e.g., the industrial computer 129 of FIG. 1). Also in example FIG. 5, the control aspect 506 runs on a physical deterministic controller (e.g., the physical deterministic controller 131 of FIG. 1). The physical equipment 508 includes a field device such as the pump 212, the valve 216, and/or the fluid level sensor 220 of FIG. 2.

In the inner and outer control environment 500, the edge aspect 504 analyzes operations of the physical equipment 508 to gain insights for configuration adjustments for subsequent operation. The edge aspect 504 may generate control actions that include, for example, configuration information to control or adjust operation of the physical equipment 508. For example, the physical equipment 508 sends an example sense message 512 that includes equipment data (e.g., collected monitoring data) to the control aspect 506. The equipment data pertains to operation of the physical equipment 508 and may include any type of measurement data (e.g., flow rate, speed, temperature, pressure, compressed air consumption, air leakage status, etc.). The control aspect 506 sends an example request advice message 514 to the edge aspect 504. The example request advice message 514 includes the equipment data provided by the physical equipment 508.

The edge aspect 504 analyzes the equipment data to generate optimized configuration information for the control aspect 506 and/or the physical equipment 508. For example, the edge aspect 504 may perform simulations of an operating environment by running the equipment data through one or more data models to generate adjusted configuration information to improve the operation of the physical equipment 508. The data models may be based on historical performance data, simulation environments, and/or any other suitable data modeling techniques. To perform data analysis and/or simulations and generate control actions as part of the outer loop 501, the edge aspect 504 may be programmed to implement one or more of fuzzy logic, soft sensors, performance monitoring, gain scheduling, proportional-integral-derivative (PID) controller tuning, model predictive control (e.g., receding horizon control), a finite state machine, or predictive maintenance.

After the edge aspect 504 generates one or more control actions for configuring the physical equipment 508, the edge aspect 504 sends an example advice message 516 including one or more control actions to the control aspect 506. The control aspect 506 sends an example actuate message 518 to the physical equipment 508 to update a configuration of the physical equipment 508 based on the one or more control actions. To control operation of the physical equipment 508 as part of the inner loop 502, the control aspect 506 may implement one or more of open-loop control (e.g., control on/off actuators in pumps, valves, etc.), closed-loop control (e.g., cascade control, override control, split rage control, single-input single-output (SISO) control, etc.), or measurement control functions (e.g., direct and/or indirect process measurements, measurement compensation, etc.).

The data collection, analysis, and configuration update process of the inner and outer control environment 500 may repeat multiple times during operation of a distributed control system to continually monitor and determine whether configuration changes should be made to physical equipment (e.g., controllers, field devices, etc.) to improve their operation. In this manner, variations in material or physical equipment operation may be compensated so that product quality, manufacturing throughput, and/or any other process parameters of a distributed control system can be maintained at target levels.

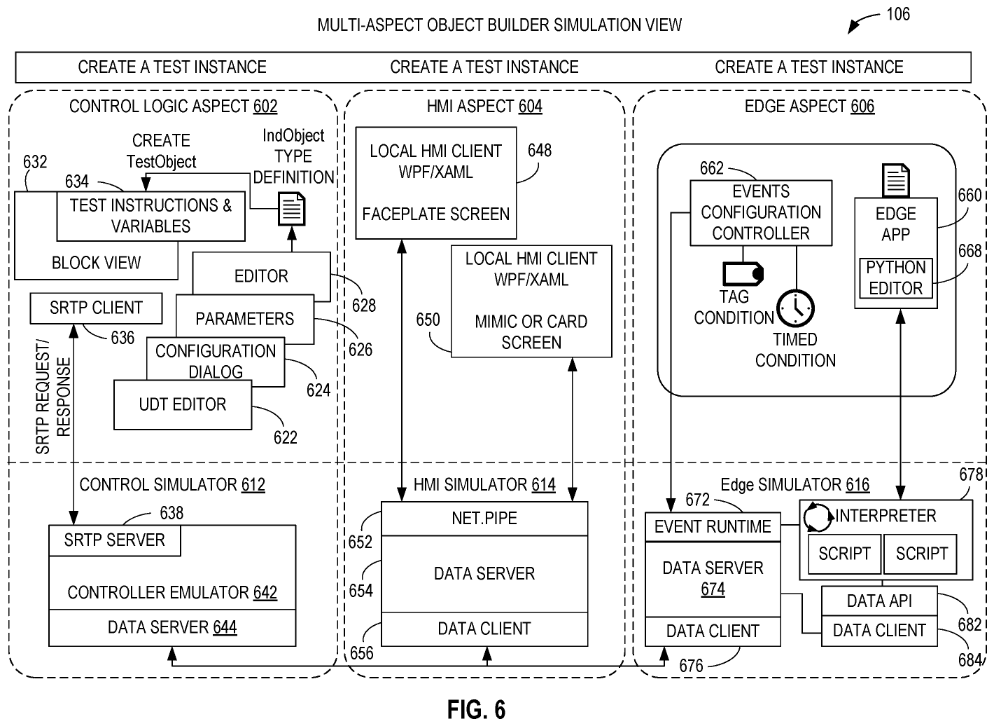

FIG. 6 is the example multi-aspect object builder 106 of FIGS. 1 and 3 that may be used to develop multi-aspect object templates and simulate corresponding multi-aspect objects to control equipment in a distributed control system. For example, during a development phase, the multi-aspect object builder 106 brings together multiple aspects of a multi-aspect object as an object-oriented composition that represents physical equipment (e.g., controllers, field devices, etc.) in a distributed control system. In example FIG. 6, the multi-aspect object builder 106 is used to develop aspect templates that may be used to create corresponding aspects such as an example control aspect 602 (e.g., to control physical equipment operation), an example HMI aspect 604 (e.g., for monitoring physical equipment operation), and an example edge aspect 606 (e.g., to analyze and optimize physical equipment operation). The multi-aspect object builder 106 also simulates the operation of aspects such as the control aspect 602, the HMI aspect 604, and the edge aspect 606.

The example multi-aspect object builder 106 creates a test instance of the control aspect 602, a test instance of the HMI aspect 604, and a test instance of the edge aspect 606. The multi-aspect object builder 106 includes an example control simulator 612, an example HMI simulator 614, and an example edge simulator 616. Through these simulators 612, 614, 616, the multi-aspect object builder 106 is able to simulate instances of different aspects such as the control aspect 602, the HMI aspect 604, and the edge aspect 606 for functionality and interoperability with one another before a corresponding multi-aspect object is deployed based on such aspects. Such simulation during the design phase of a multi-aspect object substantially reduces or eliminates the likelihood of configuration and/or functionality issues arising in the multi-aspect object during deployment.

To build the control aspect 602, the multi-aspect object builder 106 includes an example user-defined data type (UDT) editor 622, an example configuration dialog 624, example parameters 626, and an example editor 628. The UDT editor 622 allows a user to re-use previously created information in subsequent aspect instances. The configuration dialog 624 is provided to interact with a developer via one or more GUIs to receive configuration information for the control aspect 602. The parameters 626 correspond to properties or attributes of the control aspect 602. Parameter values for the parameters 626 may be obtained from user input submitted by a user via the configuration dialog 624. The editor 628 may be implemented using a ladder diagram (LD) editor or a structured text (ST) editor to edit a configuration of the control aspect 602 based on parameter values obtained for the parameters 626.

The multi-aspect object builder 106 generates an example block view 632 of the control aspect 602 based on a configuration provided via the editor 628. The block view 632 is a graphical representation of the control aspect 602 so that a developer can review a configuration of the control aspect 602 when using the multi-aspect object builder 106. In example FIG. 6, the editor 628 provides example test instructions and variables 634 in the block view 632 for simulation testing. The multi-aspect object builder 106 also includes an example secure real-time transport protocol (SRTP) client 636 to communicate with an example SRTP server 638 in the control simulator 612. The SRTP client 636 sends configuration information of the control aspect 602 and the test instructions and variables 634 to the SRTP server 638 for use by the control simulator 612 to simulate the control aspect 602.

The control simulator 612 includes an example controller emulator 642 and an example data server 644. The controller emulator 642 virtualizes controller hardware such as the physical deterministic controller 131 of FIG. 1. The data server 644 provides simulated equipment data to the controller emulator 642 and to data clients in other aspect simulators (e.g., the HMI data client 656 in the HMI simulator 614 and the edge data client 676 in the edge simulator 616). In this manner, the data server 644 collaborates with data clients of other aspects to simulate functionality of a multi-aspect object in the multi-aspect object builder 106 based on simulated physical equipment without needing to rely on actual physical equipment. Using such data collaboration and simulation, the multi-aspect object builder 106 can be used to validate and confirm the operation of the multi-aspect object and its different components by running it offline in a simulated environment before publishing a corresponding multi-aspect object template for use in deployment.

In some examples, the data server 644 is implemented using an OPC UA data server to provide data in a format interpretable by aspects and semantic data models of multi-aspect objects under simulation. However, any other suitable type of data server may be used. The simulated equipment data represents data generated by physical equipment such as controllers (e.g., the physical deterministic controller 131 of FIG. 1) and field devices (e.g., the pump 212 or the valve 216 of FIG. 2). The simulated equipment data is used by the controller emulator 642 to simulate real operation of the control aspect 602 by running the control aspect 602 on the virtualized controller hardware based on the simulated equipment data from the data server 644 and based on the configuration information of the control aspect 602 and the test instructions and variables 634 received from the SRTP client 636.

Through a user interface of the multi-aspect object builder 106, a developer can interact with the control simulator 612 to view operation, performance, errors, warnings, notifications, etc. of the simulated control aspect 602. In addition, the multi-aspect object builder 106 can receive user input from the developer and apply information from that user input to change configuration information of the control aspect 602, make changes to the test instructions and variables 634, and/or select different simulated equipment data in the data server 644. In this manner, the multi-aspect object builder 106 may run multiple simulations for different configurations of the control aspect 602 to improve performance of the control aspect 602. The multi-aspect object builder 106 may generate one or more control action(s) based on the simulations to modify one or more configuration(s) for the control aspect 602 to satisfy one or more performance target(s). For example, performance targets may be based on product composition, product consistency, product quality, manufacturing throughput, and/or any other suitable target. The multi-aspect object builder 106 can present the control action(s) for review by the developer. In response to user input specifying a selection of one of the control actions, the multi-aspect object builder 106 updates and finalizes (e.g., compiles) the control aspect 602 for deployment (e.g., in the deployment environment 110 of FIG. 1).

To configure the HMI aspect 604, the multi-aspect object builder 106 implements one or more screen interfaces in the HMI aspect 604. Example screen interfaces are shown in FIG. 6 as an example faceplate screen 648 and an example MIMIC or card screen 650. Each of the faceplate screen 648 and the MIMIC or card screen 650 is implemented using a local HMI client application programmed using Windows Presentation Foundation (WPF)/Extensible Application Markup Language (XAML), Movicon, or Power Monitoring Expert (PME) View. In example FIG. 6, the faceplate screen 648 is a pop-up GUI that provides information about a selected component of a distributed control system. For example, if user input specifies a mouse click or other selection of a pump controller, the HMI aspect 604 generates the faceplate screen 648 to display configuration information, operating parameters, measurement values, or other information corresponding to the selected pump controller.

The MIMIC or card screen 650 provides a system-level representation of a distributed control system. For example, the MIMIC or card screen 650 may be implemented using Mimic™ Simulation Software by Emerson Electric Company to provide real-time or substantially real-time simulation of plant behaviors. Additionally or alternatively, the HMI aspect 604 may implement the MIMIC or card screen 650 as a GUI that displays information generated by a DeltaV™ Sequence of Events Card by Emerson Electric Company. In such examples, the DeltaV™ sequence of events card records events associated with a process by using time stamps to determine an order in which the events occurred.

To test operability of the HMI aspect 604 and its ability to generate the screen interfaces 648, 650, the HMI simulator 614 of the multi-aspect object builder 106 includes an example network interface 652, an example data server 654, and an example HMI data client 656. The network interface 652 communicates with the HMI aspect 604 to provide information to the screen interfaces 640, 650 and to receive user input provided via the screen interfaces 648, 650. The HMI data client 656 receives simulated equipment data from the data server 644 and simulates a physical client that is to access information from physical equipment in a distributed control system and/or provide information to the physical equipment. For example, the HMI data client 656 may simulate an operator workstation of a distributed control system that requests monitoring data from physical equipment and that provides user input configuration information received via the screen interfaces 648, 650 to configure the physical equipment. By providing the data server 644 to simulate physical equipment in a distributed control system and the HMI data client 656 to simulate operator stations, simulated data can be provided to the screen interfaces 648, 650 via the network interface 652 during testing of the HMI aspect 604. In some examples, the HMI data client 656 is implemented using an OPC UA data client that receives data in a format interpretable by aspects and semantic data models of multi-aspect objects under simulation. However, any other suitable type of data client may be used.

The data server 654 is to serve simulated equipment data from the HMI data client 656 to the HMI aspect 604 via the network interface 652 to be displayed via the screen interfaces 640, 650. For example, the data server 654 may store simulated process control data corresponding to controllers, field devices, and/or any other physical equipment in a distributed control system that matches or is substantially the same as physical equipment pertaining to the HMI aspect 604. The data server 654 can provide that data to the screen interfaces 640, 650 when requested by the HMI aspect 604 based on what content is requested for display in the screen interfaces 640, 650. In some examples, the data server 654 is implemented using an OPC UA data server that provides data in a format interpretable by aspects and semantic data models of multi-aspect objects under simulation. However, any other suitable type of data client may be used.

To configure the edge aspect 606, the multi-aspect object builder 106 implements an example edge application 660 and an example events configuration controller 662 in the edge aspect 606. Similar to the edge application of the edge aspect 504 of FIG. 5, the edge application 660 analyzes operations of physical equipment in a distributed control system to gain insights and generate control actions including configuration adjustments of the physical equipment. In example FIG. 6, the edge application 660 includes an example Python editor 668. The Python editor 668 provides a user interface via which a developer may write Python scripts to develop functions, routines, or algorithms in the edge application 664 for use in analyzing collected data and generating configuration actions.

The events configuration controller 662 generates data collection event definitions that specify criteria or conditions that trigger the edge simulator 616 to collect data corresponding to physical equipment and a simulated distributed control system. For example, the events configuration controller 662 may define a data collection event to collect data based on a timed condition such a periodic basis based on time intervals, at a specific time or times, etc. Additionally or alternatively, the events configuration controller 662 may define a data collection event to collect data based on data tag conditions such as when a measurement value (e.g., a temperature measurement, a pressure measurement, a flow measurement, etc.) satisfies a threshold, when an error occurs, etc. The events configuration controller 662 may define data collection events for particular physical equipment or for all physical equipment in a distributed control system.

To test operability of the edge aspect 606 and its ability to analyze collected data and generate configuration actions, the edge simulator 616 of the multi-aspect object builder 106 includes an example event runtime platform 672, an example data server 674, an example edge data client 676, an example interpreter 678, an example data API 682, and an example interpreter data client 684. The example event runtime platform 672 is configured by data collection event definitions provided by the events configuration controller 662. In this manner, the event runtime platform 672 simulates criteria or conditions defined in the data collection event definitions to trigger the edge simulator 616 to collect data corresponding to physical equipment specified in the data collection event definitions.

The edge data client 676 receives simulated equipment data from the data server 644 and simulates a physical client that is to access information from physical equipment in a distributed control system and/or provide information to the physical equipment. For example, the edge data client 676 may simulate an operator workstation of a distributed control system that requests monitoring data from physical equipment and that provides user input configuration information to configure the physical equipment. By providing the data server 644 to simulate physical equipment in a distributed control system and the edge data client 676 to simulate operator stations, simulated data can be provided to the edge application 660 based on data collection event definitions during testing of the edge aspect 606.

The data server 674 is to serve simulated equipment data from the edge data client 676 to the interpreter data client 684 in response to data collection events triggered by the event runtime platform 672. For example, the data server 674 may store simulated equipment data corresponding to controllers, field devices, and/or any other physical equipment in a distributor control system that matches or is substantially the same as physical equipment pertaining to the edge aspect 606. In some examples, the data server 674 is implemented using an OPC UA data server that provides data in a format interpretable by aspects and semantic data models of multi-aspect objects under simulation. However, any other suitable type of data client may be used.

The interpreter 678 interprets program instructions (e.g., script) in the edge application 660 to analyze data and generate control actions. The interpreter 678 interacts with the event runtime platform 672 to determine when data collection events are triggered. Based on determinations of triggered data collection events, the interpreter 678 communicates with the data server 674 through the data API 682 and the interpreter data client 684 to access collected data from the data server 674 during simulation. The interpreter 678 can then analyze the collected data based on the program instructions from the edge application 660 and generate corresponding control actions to improve operation of physical equipment for which the edge application 660 is programmed to monitor. In some examples, the interpreter data client 684 is implemented using an OPC UA data client that provides data in a format interpretable by aspects and semantic data models of multi-aspect objects under simulation. However, any other suitable type of data client may be used.

The simulators 612, 614, 616 may iteratively simulate different versions of the control aspect 602, the HMI aspect 604, and/or the edge aspect 606 until satisfactory results are achieved. For example, criteria or conditions defining such satisfactory results may be based on one or more of performance thresholds, operations free from errors, quality of service (QoS) thresholds, etc. In any case, such criteria or conditions may be defined or specified in user input received in the multi-aspect object builder 106 from a developer. When the simulation is complete, the multi-aspect object builder 106 finalizes (e.g., compiles, packages, etc.) a multi-aspect object template including a control aspect template corresponding to the control aspect 602, an HMI aspect template corresponding to the HMI aspect 604, and an edge aspect template corresponding to the edge aspect 606. The multi-aspect object builder 106 may then publish the multi-aspect object template to the object repository 114 (FIG. 1). In this manner, the solution builder 108 of FIGS. 1 and 3 may subsequently retrieve the multi-aspect object template from the object repository 114 to create and deploy a corresponding multi-aspect object in the deployment environment 110 (FIG. 1).

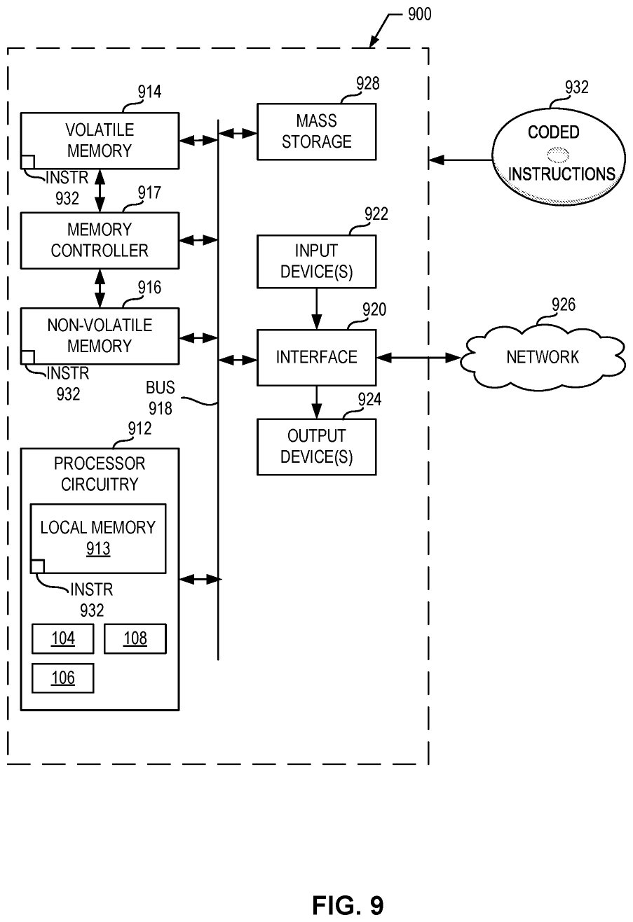

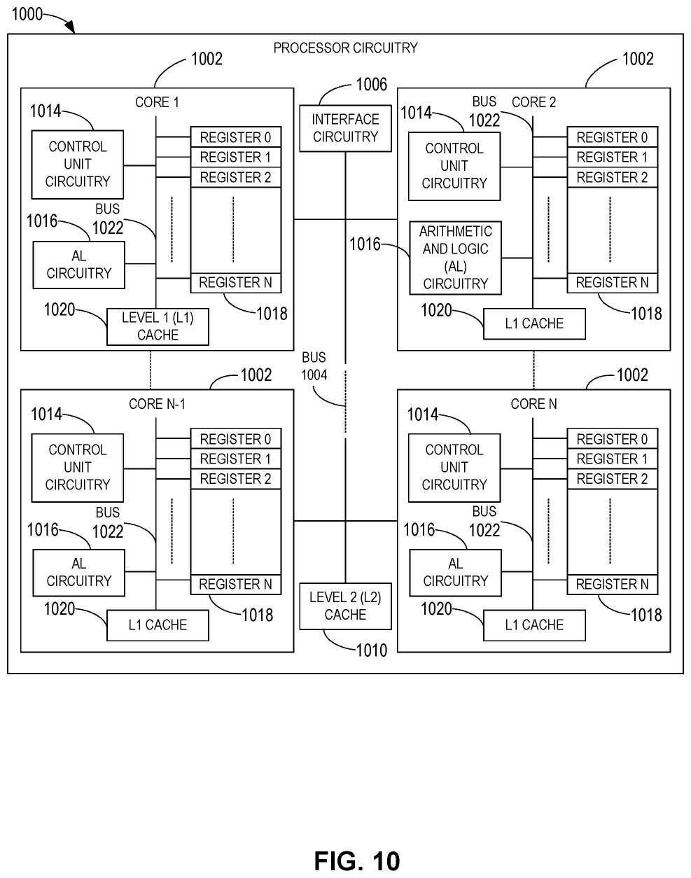

Flowchart(s) representative of example machine-readable instructions, which may be executed by programmable circuitry to implement and/or instantiate the PAC design hub 104, the multi-aspect object builder 106, the solution builder 108, the deployment environment 110, and components therein of FIG. 1 and/or representative of example operations which may be performed by programmable circuitry to implement and/or instantiate the PAC design hub 104, the multi-aspect object builder 106, the solution builder 108, the deployment environment 110, and components therein of FIG. 1, are shown in FIGS. 7 and 8. The machine-readable instructions may be one or more executable program(s) or portion(s) of one or more executable program(s) for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine-readable storage media such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, read-only memory (ROM), a solid-state drive (SSD), non-volatile memory (e.g., electrically erasable programmable ROM (EEPROM), flash memory, etc.), volatile memory (e.g., Random Access Memory (RAM) of any type, etc.), and/or any other storage device or storage disk. The non-transitory computer readable storage medium may include one or more mediums and/or types of mediums. The instructions of the non-transitory computer readable and/or machine-readable medium may be executed and/or instantiated by one or more hardware devices other than the programmable circuitry and/or may be embodied in dedicated hardware. For example, any or all of the blocks of the flowchart(s) may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform corresponding operations without executing software or firmware.

Although the example program(s) is/are described with reference to the flowchart(s) illustrated in FIGS. 7 and 8, many other methods of implementing the example PAC design hub 104, the multi-aspect object builder 106, the solution builder 108, the deployment environment 110, and components therein may alternatively be used. For example, the order of execution of the blocks of the flowchart(s) may be changed, and/or some of the blocks described may be changed, eliminated, or combined.

The machine-readable instructions may be distributed across multiple hardware devices and/or executed by two or more hardware devices (e.g., a server and a client hardware device). The programmable circuitry may be distributed in different network locations and/or may be local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

Machine-readable instructions as described herein may be stored as data and/or in a data structure (e.g., as portion(s) of instructions, code, representations of code, etc.) on one or more storage devices, disks and/or computing devices (e.g., servers) located at the same or different locations of a network or collection of networks (e.g., in the cloud, in edge devices, etc.).

The machine-readable instructions described herein can be written or represented using any suitable previously developed or future-developed instruction language, scripting language, programming language, etc. including, for example, C, C++, Java, C#, Perl, Python, JavaScript, HyperText Markup Language (HTML), Structured Query Language (SQL), Swift, etc.

As mentioned above, the example operations of FIGS. 7 and 8 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. As used herein, the terms “non-transitory computer-readable storage device” and “non-transitory machine readable storage device” are defined to include any physical (mechanical, magnetic and/or electrical) hardware to retain information for a time period, but to exclude propagating signals and to exclude transmission media. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc. As used herein, the term “storage disk” refers to a physical structure containing information storage elements to which information can be written and persisted for subsequent retrieval by a computer or other hardware platform. Examples of non-transitory computer-readable medium, non-transitory computer-readable storage medium, non-transitory machine-readable medium, non-transitory machine-readable storage medium, non-transitory computer-readable storage devices, non-transitory machine-readable storage devices, non-transitory computer-readable storage disk, and/or non-transitory machine-readable storage disk include any one of or combination of random access memory (RAM) of any type, read only memory (ROM) of any type, solid state memory, flash memory, optical discs (e.g., a CD, a DVD, etc.), magnetic disks (e.g., magnetic HDDs), disk drives, cache, registers, redundant array of independent disks (RAID) systems, and/or any other non-transitory computer-readable and/or machine-readable media in which information is stored for any duration (e.g., for extended time periods, permanently, for brief instances, for temporarily buffering, and/or for caching of the information).

FIG. 7 is a flowchart representative of example machine readable instructions and/or example operations 700 that may be executed, instantiated, and/or performed by example programmable circuitry to implement the multi-aspect object builder 106 of FIGS. 1, 3, and 6 to create multi-aspect object templates. For example, the instructions and/or operations 700 can be used to build a multi-aspect object template for a control application that includes different aspects. The instructions and/or operations 700 can build such a multi-aspect object template starting from any of a number of different available aspects. In some examples, some aspects have enhancements beyond data that is provided by a corresponding semantic data model template of a multi-aspect object template. For example, the instructions and/or operations 700 can be used to add logic (e.g., machine-readable instructions and/or configurations) in a control block of an aspect without that added logic being implemented in the corresponding semantic data model template yet ensuring that a resulting semantic data model will remain synchronized with the aspect when deployed.

When the multi-aspect object builder 106 adds a particular aspect to a multi-aspect object template during development, the instructions and/or operations 700 can reuse configuration information of that aspect template when a developer elects to add another aspect template to the multi-aspect object template. For example, if the multi-aspect object builder 106 adds an HMI aspect template, a data structure may be configured in the HMI aspect template as part of an HMI graphic template. When a control aspect template is subsequently added and configured to include control logic of, for example, a gauge, a pilot light, etc., configuration information of that control logic can be implied and inherited by the data structure of the HMI aspect template. As such, regardless of which of the HMI aspect template or the control aspect template are added first to a multi-aspect object template, the relationship of both aspect templates with the same multi-aspect object template causes configuration information to be implied or inherited to other previously added or subsequently added aspect templates. Similarly, enhancing, updating, or revising one aspect template at a later time causes updates to propagate to other aspect templates of the multi-aspect object template. For example, if control logic for a gauge or pilot light is removed from or updated in the control aspect template, the change is automatically propagated to corresponding configuration information in the data structure of the collaborating HMI aspect template and/or in any other collaborating aspect template (e.g., an edge aspect template) of the same multi-aspect object template.

The machine-readable instructions and/or operations 700 can start with a multi-aspect object framework that includes a base or starter semantic data model template. If a developer does not add any aspect templates, the multi-aspect object builder 106 compiles a multi-aspect object template based on only the semantic data model template and any additional functionality (e.g., data processing, data algorithms, etc.) a developer elects to include in the semantic data model template. However, when the developer elects to add one or more aspect templates to the multi-aspect object template, the machine-readable instructions and/or operations 700 can be executed in iterative fashion one or more times to add any number of aspect templates to the multi-aspect object template. During the addition of each aspect, configuration information of that aspect template is inherited into the semantic data model template of the multi-aspect object template. In this manner, the semantic data model template allows previously or subsequently added aspect templates of the same multi-aspect object template to discover and inherit configuration information of other aspect templates to enable collaboration between the different aspects. When the developer indicates that no other aspect templates are to be added, the multi-aspect object builder 106 finalizes and compiles the multi-aspect object template. The multi-aspect object template can then be subsequently used one or more times as a basis for generating and deploying multi-aspect objects in a distributed control system.

The machine-readable instructions and/or operations 700 of FIG. 7 begin at block 702, at which the aspect builder 120 (FIG. 1) determines which aspect template to add in a multi-aspect object template. If the aspect builder 120 determines to add an HMI aspect template (block 702: HMI aspect), control advances to block 704 at which the aspect builder 120 creates an HMI screen. For example, a developer may provide user input to configure the HMI screen to include a GUI that allows a user to monitor and/or operate physical equipment in a distributed control system.

The aspect builder 120 creates an HMI data model template based on the HMI screen (block 706). For example, the aspect builder 120 creates the HMI data model template to be implemented in a semantic data model template. The HMI data model template is to program a semantic data model to receive data from and provide data to the HMI screen generated at block 704. That is, the HMI data model template is generated by the aspect builder 120 to include data formatting information indicative of a data format in which the HMI aspect expects to receive data from the semantic data model and in which the HMI aspect will generate data to share with the semantic data model. In this manner, a semantic data model can perform data format conversions on data to and from the HMI aspect.

Returning to block 702, if the aspect builder 120 determines to add a control aspect template (block 702: control aspect), the aspect builder 120 obtains a control algorithm (block 708). For example, the aspect builder 120 obtains the control algorithm from a programming editor when written by a developer. Alternatively, the aspect builder 120 obtains the control algorithm from a code library based on user input from a developer specifying selection of the control algorithm in the code library. In any case, the aspect builder 120 incorporates the control algorithm in the control aspect template to implement control logic to control physical equipment in a distributed control system.

The aspect builder 120 creates a control data model template to parameterize the control algorithm for reuse (block 710). For example, the aspect builder 120 creates a control data model template that includes the control algorithm as a parameter or multiple parameters that can be customized to implement the control algorithm for a particular use in the control aspect. In some examples, parameterizing the control algorithm in the control data model template also allows the control algorithm to be selected and customized at a later time when a same user or other users select that control data model template to implement a control aspect. When generating the control data model template, the aspect builder 120 generates data formatting information indicative of a data format in which the control aspect expects to receive data from the semantic data model and in which the control aspect will generate data to share with the semantic data model. In this manner, a semantic data model can perform data format conversions on data to and from the control aspect.

Returning to block 702, when the aspect builder 120 determines to add any other aspect template to the multi-aspect object (block 702: other aspect), control advances to block 712. At block 712, the aspect builder 120 creates another aspect template for the multi-aspect object template. For example, the aspect builder 120 may create a Python class template for an edge aspect template or any other type of template for the other aspect template to be added. If the aspect builder 120 adds an edge aspect template, the edge aspect provides the capability to a multi-aspect object to access a control action from an edge application (e.g., the edge application of the edge aspect 504 of FIG. 5 or the edge application 660 of FIG. 6) running independent of physical equipment during deployment. For example, the edge application may generate the control action based on running status information of the physical equipment through a simulation of operation. In this manner, the multi-aspect object can use the control action to control the physical equipment. For example, the control action may include configuration settings to apply in the physical equipment to change (e.g., improve) its operation.

The aspect builder 120 creates a data model template based on the additional aspect template (block 714). For example, the aspect builder 120 generates data formatting information indicative of a data format in which the additional aspect expects to receive data from the semantic data model and in which the additional aspect will generate data to share with the semantic data model. In this manner, a semantic data model can perform data format conversions on data to and from the additional aspect.

After the aspect builder 120 is finished adding an aspect template at block 706, block 710, or block 714, the object assembler 122 (FIG. 1) generates or updates a multi-aspect object template (block 716). For example, the multi-aspect object template includes any recently added aspect template in addition to any previously added aspect template. In generating/updating the multi-aspect object template at block 716, the object assembler 122 updates a corresponding semantic data model template of the multi-aspect object template. For example, the semantic data model template is initially configured with a general data conversion framework to convert or translate aspect data to a format that is compatible with all of the aspects of the multi-aspect object. When an aspect template is added, the object assembler 122 updates the semantic data model template to inherit configuration information of the added aspect template. For example, the object assembler 122 updates the semantic data model template of the multi-aspect object template to include data formatting information and/or other data model information generated at blocks 706, 710, 714 for the different aspect templates. By inheriting configuration information such as data formatting information and/or other data model information into the semantic data model template, the semantic data model template is updated to implement data format conversions for different features of the added aspect templates and to enable communications with the different aspects based on I/O configurations of the aspects. Inheriting the configuration information of an aspect template into the semantic data model template also makes that configuration information implicit or available to other, previously or subsequently, added aspects of the multi-aspect object template.

In some examples, during the generating or updating of the multi-aspect object template at block 716, the multi-aspect object builder 106 runs a multi-aspect object corresponding to the multi-aspect object template offline by deploying the multi-aspect object in a virtualized environment based on a virtualized implementation of physical equipment as described above in connection with FIG. 6. The multi-aspect object builder 106 can perform the virtualized deployment of the multi-aspect object based on simulators (e.g., the simulators 612, 614, 616 of FIG. 6) in the multi-aspect object builder 106 to verify functionality of the aspects of the multi-aspect object as described above in connection with FIG. 6. For example, the multi-aspect object builder 106 can validate functionality of the multi-aspect object based on interoperability of the aspects with the virtualized implementation of the physical equipment and based on interoperability of a semantic data model with the aspects. In some examples, the object assembler 122 generates or updates the multi-aspect object template after verification of correct functionality under simulation. Otherwise, if correct functionality is not achieved, properties, attributes, or parameters associated with one or more aspects can be modified before the object assembler 122 generates or updates the multi-aspect object template.

The aspect builder 120 determines whether to add another aspect template (block 718). For example, another aspect template may be added in response to user input requesting an additional aspect template in the multi-aspect object template. If the aspect builder 120 determines to add another aspect template (block 718: YES), control returns to block 702. Otherwise, if the aspect builder 120 determines not to add another aspect template (block 718: NO), control advances to block 720 at which the object assembler 122 saves the multi-aspect object template. For example, the object assembler 122 saves the multi-aspect object template to a local disk and/or publishes the multi-aspect object template to the object repository 114 (FIGS. 1 and 3). In this manner, the multi-aspect object template can be used by the same user that created the multi-aspect object template or by other users to create industrial multi-aspect IndObject Types (e.g., the industrial multi-aspect IndObject Types 222, 224, 226, 228 of FIG. 2) and instantiate corresponding multi-aspect objects (e.g., the industrial objects 206, 210, 214, 218 of FIG. 2) for use in different distributed control systems. The instructions and/or operations 700 of FIG. 7 end.

FIG. 8 is a flowchart representative of example machine readable instructions and/or example operations 800 that may be executed, instantiated, and/or performed by example programmable circuitry to implement the solution builder 108 of FIGS. 1 and 3 to generate multi-aspect objects based on multi-aspect object templates. The example machine-readable instructions and/or the example operations 700 of FIG. 7 begin at block 702, at which the object builder 124 (FIG. 1) selects a multi-aspect object template (block 802). For example, the object builder 124 may select a multi-aspect object template from the object repository 114 (FIGS. 1 and 3) based on user input from a developer specifying that multi-aspect object template. The object builder 124 creates a multi-aspect object (block 804). For example, the object builder 124 creates the multi-aspect object based on an industrial multi-aspect IndObject Type corresponding to the multi-aspect object template selected at block 802. The object builder 124 assigns a first capability to the multi-aspect object (block 806). For example, the first capability assigned by the object builder 124 is a first aspect (e.g., an HMI aspect, and edge aspect, a security aspect, a control aspect, etc.) defined in the multi-aspect object template of block 802. In assigning the first capability, the object builder 124 generates a first interface through which the first capability is to communicate with corresponding physical equipment in an industrial control system. The object builder 124 assigns a second capability to the multi-aspect object (block 808). For example, the second capability assigned by the object builder 124 is a second aspect (e.g., an HMI aspect, and edge aspect, a security aspect, a control aspect, etc.) defined in the multi-aspect object template of block 802. In assigning the second capability, the object builder 124 generates a second interface through which the second capability is to communicate with corresponding physical equipment in an industrial control system. Although the flowchart of FIG. 8 is shown as adding only two capabilities or aspects to the multi-aspect object, fewer or more capabilities or aspects may be added to the multi-aspect object based on user input requesting the addition of aspects from the multi-aspect object template to the instantiated multi-aspect object.

The object builder 124 creates a semantic data model (block 810). For example, the object builder 124 creates a semantic data model based on a semantic data model template of the multi-aspect object template of block 802. The object builder 124 creates the semantic data model to include data format conversion functionality based on data format descriptions provided in the semantic data model template for aspects added in the multi-aspect object. In this manner, the semantic data model can share information between the first capability and the second capability (and/or any other capabilities or aspects) of the multi-aspect object. The deployment manager 127 (FIG. 1) deploys the multi-aspect object (block 812). During deployment, the deployment manager 127 deploys the multi-aspect object in a deployment environment such as the deployment environment 110 (FIG. 1) so that the different aspects of the multi-aspect object execute on corresponding runtime platforms (e.g., the runtime platforms 128, 130, 132, 134 of FIG. 1). For example, the first capability of the multi-aspect object is deployed to execute on a first runtime platform and the second capability of the multi-aspect object is deployed to execute on a second runtime platform. Also during the deployment, the deployment manager 127 deploys the semantic data model to communicate between the first and second runtime platforms to share information between the first and second capabilities of the multi-aspect object. The machine readable instructions and/or operations 800 of FIG. 8 end.

FIG. 9 is a block diagram of an example programmable circuitry platform 900 structured to execute and/or instantiate the example machine-readable instructions and/or the example operations of FIGS. 7 and 8 to implement the PAC design hub 104, the multi-aspect object builder 106, the solution builder 108, and components therein of FIG. 1. The programmable circuitry platform 900 may also be used to implement the industrial computer 129, the physical deterministic controller 131, the OS-based server 133, the intelligent device 135, and/or the industrial object server 136 of the deployment environment 110 of FIG. 1. The programmable circuitry platform 900 can be, for example, a server, a personal computer, a workstation, a self-learning machine (e.g., a neural network), or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, XPUs, and/or microcontrollers from any desired family or manufacturer. The programmable circuitry 912 may be implemented by one or more semiconductor based (e.g., silicon based) devices. In this example, the programmable circuitry 912 implements the PAC design hub 104, the multi-aspect object builder 106, the solution builder 108, and components therein.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices, optical storage devices, RAID systems, and/or solid-state storage discs or devices such as flash memory devices and/or SSDs.

The machine-readable instructions 932, which may be implemented by the machine-readable instructions of FIGS. 7 and 8, may be stored in the mass storage device 928, in the volatile memory 914, in the non-volatile memory 916, and/or on at least one non-transitory computer readable storage medium which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 and/or components thereof may include additional and/or alternate structures to those shown and described below. The microprocessor 1000 is a semiconductor device fabricated to include transistors interconnected to implement the structures described below in one or more integrated circuits (ICs) contained in one or more packages.

The microprocessor 1000 executes machine-readable instructions of the flowcharts of FIGS. 7 and 8 to instantiate the circuitry of FIG. 1 as logic circuits to perform operations corresponding to those machine-readable instructions. In some such examples, the circuitry of FIG. 1 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine-readable instructions. For example, machine code corresponding to a firmware program, an embedded software program, or a software program represented by the flowcharts of FIGS. 7 and 8 may be executed by one of the cores 1002 or may be executed by multiple ones of the cores 1002 at the same or different times.

The cores 1002 may communicate by a first example bus 1004. For example, the first bus 1004 may be implemented by any suitable bus technology (e.g., an Inter-Integrated Circuit (I2C) bus, a Serial Peripheral Interface (SPI) bus, a PCI bus, a PCIe bus etc.). Data, instructions, and/or signals may be communicated (e.g., accessed, obtained, output, provided, etc.) between the cores 1002 and one or more external devices by example interface circuitry 1006. Although the cores 1002 of this example include example local cache 1020 (e.g., Level 1 (L1) cache that may be split into an L1 data cache and an L1 instruction cache), the microprocessor 1000 also includes example shared cache 1010. The shared cache 1010 is shared by the cores (e.g., Level 2 (L2 cache)) to access data and/or instructions across the cores.

Each core 1002 includes control unit circuitry 1014, arithmetic and logic (AL) circuitry (sometimes referred to as an arithmetic logic unit (ALU)) 1016, a plurality of registers 1018 (e.g., hardware registers), the local cache 1020, and a second example bus 1022. The control unit circuitry 1014 controls (e.g., coordinates) data movement within the corresponding core 1002. The AL circuitry 1016 performs one or more mathematic and/or logic operations on the data within the corresponding core 1002.

The registers 1018 store data and/or instructions such as results of operations performed by the AL circuitry 1016. The second bus 1022 may be implemented using any suitable bus technology (e.g., an I2C bus, a SPI bus, a PCI bus, or a PCIe bus, etc.).

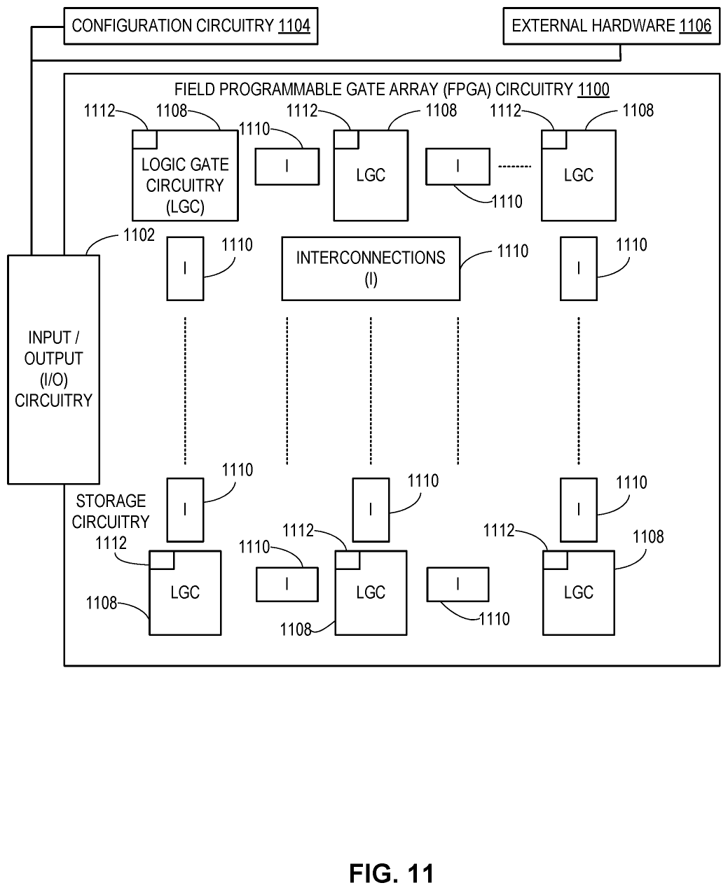

FIG. 11 is a block diagram of another example implementation of the programmable circuitry 912 of FIG. 9. In this example, the programmable circuitry 912 is implemented by FPGA circuitry 1100. Programmable logic circuitry of the FPGA circuitry 1100 may be programmed to create dedicated logic circuits that perform operations and/or functions represented in the flowchart(s) of FIGS. 7 and 8. For example, the FPGA circuitry 1100 includes interconnections and logic circuitry (e.g., logic gates, switches, etc.) that may be configured, structured, programmed, and/or interconnected in different ways to instantiate some or all of the operations/functions corresponding to the machine-readable instructions represented by the flowchart(s) of FIGS. 7 and 8. After an FPGA programming process, the FPGA circuitry 1100 instantiates the operations and/or functions corresponding to the machine-readable instructions in hardware. In some examples, the FPGA circuitry 1100 can execute the operations/functions faster than they could be performed by a general-purpose microprocessor.

The FPGA circuitry 1100 of FIG. 11, includes example input/output (I/O) circuitry 1102 to obtain data from and/or output data to example configuration circuitry 1104 and/or external hardware 1106 (e.g., microprocessor circuitry, controller circuitry, memory circuitry, storage circuitry, a computer, etc.). For example, the configuration circuitry 1104 may be implemented by interface circuitry that obtains a binary file to program or configure the FPGA circuitry 1100.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to machine-readable instructions of FIGS. 7 and 8 and/or other desired operations.

The storage circuitry 1112 is structured to store result(s) of operations performed by corresponding logic gates. The storage circuitry 1112 may be implemented by registers or the like.

Although not shown, the example FPGA circuitry 1100 of FIG. 11 also includes example dedicated operations circuitry to implement functions without programming those functions in the logic gate circuitry 1108. The FPGA circuitry 1100 may also include general purpose programmable circuitry such as a CPU, a DSP, etc.

Although FIGS. 10 and 11 illustrate two example implementations of the programmable circuitry 912 of FIG. 9, many other approaches are contemplated. For example, a hybrid circuitry example may include one or more cores 1002 of FIG. 10 that execute(s) a first portion of the machine-readable instructions represented by the flowchart(s) of FIGS. 7 and 8 to perform first operation(s)/function(s) and include the FPGA circuitry 1100 of FIG. 11 configured and/or structured to perform second operation(s)/function(s) corresponding to a second portion of the machine-readable instructions represented by the flowcharts of FIGS. 7 and 8, and/or include an ASIC configured and/or structured to perform third operation(s)/function(s) corresponding to a third portion of the machine-readable instructions represented by the flowcharts of FIGS. 7 and 8.

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In some examples, the programmable circuitry 912 of FIG. 9 may be in one or more packages. For example, the microprocessor 1000 of FIG. 10 and/or the FPGA circuitry 1100 of FIG. 11 may be in one or more packages.

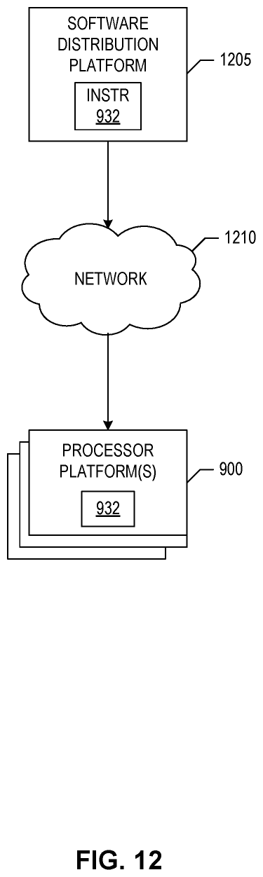

A block diagram illustrating an example software distribution platform 1205 to distribute software such as the example machine-readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. In the illustrated example, the software distribution platform 1205 includes one or more servers and one or more storage devices. The storage devices store the machine-readable instructions 932, which may correspond to the example machine-readable instructions of FIGS. 7 and 8, as described above. The one or more servers of the example software distribution platform 1205 are in communication with an example network 1210, which may correspond to any one or more of the Internet and/or any of the example networks described above. The servers enable downloading the machine-readable instructions 932 from the software distribution platform 1205. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include any circuitry that can be programmed or configured to perform different operations and that includes one or more semiconductor-based logic devices (e.g., electrical hardware implemented by one or more transistors. Programmable circuitry may be: (i) one or more special purpose electrical circuits (e.g., an ASIC) and/or (ii) one or more general purpose semiconductor-based electrical circuits programmable with instructions. Examples of programmable circuitry include programmable microprocessors such as CPUs, FPGAs, GPUs, DSPs, XPUs, Network Processing Units (NPUs), and/or integrated circuits such as ASICs. For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing tasks to whichever one(s) of the multiple types of programmable circuitry is/are suited and available to perform the computing tasks.

From the foregoing, it will be appreciated that example systems, apparatus, articles of manufacture, and methods have been disclosed that implement multi-aspect objects for distributed control systems. Disclosed systems, apparatus, articles of manufacture, and methods improve the efficiency of using a computing device by providing tools to generate re-useable and re-configurable multi-aspect object templates to which multiple capabilities can be added for use within the context of a computer-based distributed control system. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus to generate a multi-aspect object, the apparatus comprising:
memory;
instructions; and
programmable circuitry to be programmed by the instructions to:
create the multi-aspect object;
assign a first capability to the multi-aspect object, the first capability to communicate with equipment in a control system;
assign a second capability to the multi-aspect object, the second capability to communicate with the equipment in the control system;
create a semantic data model in the multi-aspect object, the semantic data model to share information between the first capability and the second capability of the multi-aspect object;
deploy the first capability of the multi-aspect object on a first runtime platform; and
deploy the second capability of the multi-aspect object on a second runtime platform, the semantic data model to communicate between the first and second runtime platforms to share the information between the first and second capabilities of the multi-aspect object.

2. The apparatus of claim 1, wherein the equipment includes a controller.

3. The apparatus of claim 1, wherein the first capability is control logic to control the equipment.

4. The apparatus of claim 1, wherein the second capability is a human-machine interface to at least one of monitor or operate the equipment via a user interface.

5. The apparatus of claim 1, wherein the multi-aspect object is a higher-level object, the programmable circuitry to deploy a capability of a lower-level object on at least one of the first runtime platform or the second runtime platform.

6. The apparatus of claim 1, wherein the programmable circuitry is to:
deploy the multi-aspect object in a virtualized environment based on a virtualized implementation of the equipment; and
validate functionality of the multi-aspect object based on interoperability of the first and second capabilities with the virtualized implementation of the equipment and based on interoperability of the semantic data model with the first and second capabilities.

7. The apparatus of claim 1, wherein the programmable circuitry is to select a multi-aspect object template from a repository to create the multi-aspect object, the repository including a plurality of other multi-aspect object templates, the multi-aspect object template and the plurality of other multi-aspect object templates accessible in the repository by a plurality of client devices.

8. The apparatus of claim 1, wherein the programmable circuitry is to assign an edge capability to the multi-aspect object, the edge capability to access a control action from an application running independent of the equipment, the control action corresponding to control of the equipment.

9. The apparatus of claim 8, wherein the control action is based on a status of the equipment.

10. At least one non-transitory machine-readable medium comprising machine-readable instructions to cause at least one processor circuit to at least:
create a multi-aspect object;
assign a first capability to the multi-aspect object, the first capability to communicate with equipment in a control system;
assign a second capability to the multi-aspect object, the second capability to communicate with the equipment in the control system;
create a semantic data model in the multi-aspect object, the semantic data model to share information between the first capability and the second capability of the multi-aspect object;
deploy the first capability of the multi-aspect object on a first runtime platform; and
deploy the second capability of the multi-aspect object on a second runtime platform, the semantic data model to communicate between the first and second runtime platforms to share the information between the first and second capabilities of the multi-aspect object.

11. The at least one non-transitory machine-readable medium of claim 10, wherein the equipment includes a controller.

12. The at least one non-transitory machine-readable medium of claim 10, wherein the first capability is control logic to control the equipment.

13. The at least one non-transitory machine-readable medium of claim 10, wherein the second capability is a human-machine interface to at least one of monitor or operate the equipment via a user interface.

14. The at least one non-transitory machine-readable medium of claim 10, wherein the multi-aspect object is a higher-level object, the machine-readable instructions to cause one or more of the at least one processor circuit to deploy a capability of a lower-level object on at least one of the first runtime platform or the second runtime platform.

15. The at least one non-transitory machine-readable medium of claim 10, wherein the machine-readable instructions are to cause one or more of the at least one processor circuit to:
deploy the multi-aspect object in a virtualized environment based on a virtualized implementation of the equipment; and
validate functionality of the multi-aspect object based on interoperability of the first and second capabilities with the virtualized implementation of the equipment and based on interoperability of the semantic data model with the first and second capabilities.

16. The at least one non-transitory machine-readable medium of claim 10, wherein the machine-readable instructions are to cause one or more of the at least one processor circuit to select a multi-aspect object template from a repository to create the multi-aspect object, the repository including a plurality of other multi-aspect object templates, the multi-aspect object template and the plurality of other multi-aspect object templates accessible in the repository by a plurality of client devices.

17. The at least one non-transitory machine-readable medium of claim 10, wherein the machine-readable instructions are to cause one or more of the at least one processor circuit to assign an edge capability to the multi-aspect object, the edge capability to access a control action from an application running independent of the equipment, the control action corresponding to control of the equipment.

18. The at least one non-transitory machine-readable medium of claim 17, wherein the control action is based on a status of the equipment.

19. A method to generate a multi-aspect object, the method comprising:
creating the multi-aspect object;
assigning a first capability to the multi-aspect object, the first capability to communicate with equipment in a control system;
assigning a second capability to the multi-aspect object, the second capability to communicate with the equipment in the control system;
creating a semantic data model in the multi-aspect object, the semantic data model to share information between the first capability and the second capability of the multi-aspect object; and
deploying the first capability of the multi-aspect object on a first runtime platform; and
deploying the second capability of the multi-aspect object on a second runtime platform, the semantic data model to communicate between the first and second runtime platforms to share the information between the first and second capabilities of the multi-aspect object.

20. The method of claim 19, wherein the equipment includes a controller.

21.-27. (canceled)
